(19) United States
(12) Patent Application Publication
(10) Pub. No.: US 2010/0042684 A1
(43) Pub. Date: Feb. 18, 2010

(54) ADAPTIVE USER INTERFACES AND METHODS FOR DISPLAYING, ACCESSING, AND ORGANIZING ELECTRONIC ASSETS

(75) Inventors: Todd Jeffrey Broms, New York, NY (US); David Hillel Gelernter, Woodbridge, CT (US); Louis F. Nemeth, North Haven, CT (US); Daniel Edwards Gelernter, Woodbridge, CT (US); Christopher Travers, Weston, CT (US); Joshua Haven Gelernter, Woodbridge, CT (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Managed Interface Technologies LLC, New York, NY (US)

(21) Appl. No.: 12/540,601

(22) Filed: Aug. 13, 2009

Related U.S. Application Data
(60) Provisional application No. 61/088,620, filed on Aug. 13, 2008.

(51) Int. Cl. G06F 15/16; G06F 3/048

(52) U.S. Cl. 709/204; 715/764; 709/248; 709/231

(57) ABSTRACT

A graphical user interface manages a user's electronic assets using a common protocol and displays such assets to the user using a common framework and interface. The graphical user interface includes a bar of segmented geometric structures and a set of one or more elongated streamers positioned, respectively, to form an “L-shaped” interface. The segmented geometric structures include individual “cards” that represent one or more electronic assets or groups of electronic assets stored accessible to the user. The user can share one or more of such cards via secure peer-to-peer communication without any need for uploading or attachment. The set of elongated streamers can display links to online content, advertisements targeted to the user, links to locally- or remotely-stored electronic assets, reminders of future events, and notifications of shared content. User activities can be tracked and provided to one or more third parties.

### CROSS-REFERENCE TO RELATED APPLICATIONS

This application claims the benefit of U.S. Provisional Patent Application No. 61/088,620, filed on Aug. 13, 2008 titled “Adaptive User Interfaces and Methods for Displaying, Accessing, and Organizing Electronic Assets” (Atty. Docket No. 2661.0010000), which is incorporated herein by reference in its entirety.

### FIELD OF THE INVENTION

The present invention relates to operating systems for a computer. More particularly, the present invention relates to graphical user interfaces used in conjunction with or in place of such operating systems.

### Introduction

We encounter computers and computer systems throughout our daily lives. While we take advantage of such devices in their obvious forms, such as laptop computers and desktop PCs, we also depend on a variety of less-obvious computer systems, including those found in cellular telephones, personal digital assistants, cable boxes, remote controls, video game consoles, and even within the music, video, and navigational devices of our vehicles. Therefore, modern computer users manage a large volume of data stored on various devices in a variety of forms and accessed through a variety of interfaces. As such, these modern users must be proficient in a variety of data access protocols that are specific to the various devices encountered on a daily basis. The overhead costs associated with mastering these protocols pose problems both for expert users, who must manage many devices and massive amounts of data, and beginning or inexperienced users, who must cope with the wide range of devices and often-intimidating protocols.

Computing platforms and the user community have grown and changed radically since the introduction of the windows-based desktop interface by Xerox in 1974 and Apple in 1983. However, the graphical user interfaces (GUI) of Apple and Microsoft Windows remain fundamentally unchanged since their introduction over a generation ago. Further, freely-available operating systems, such as Unix and Linux, do not currently and never have possessed an adequate, standard GUI. Unfortunately, modern computer users, who must manage large volumes of data on multiple computers and computer devices, face problems that are fundamentally different from the ones posed by the computing environment of the 1970s and 1980s and solved by these early GUIs.

### Features of the Invention

What is needed, therefore, is a graphical user interface that can cope effectively with modern conditions for creating, managing, displaying, sharing and using digital information of any form in a uniform way on a variety of platforms. As such, a graphical user interface is needed that is not only simple to operate on every important digital platform, but that is also fun to use.

In an embodiment, a graphical user interface creates, manages, displays, and uses a variety of electronic assets on multiple digital platforms using a common protocol. Such electronic assets include, but are not limited to, documents (e.g., word processing documents, spreadsheets, presentations), email, web bookmarks, Internet content, information and messages from one or more social networking website, and multimedia files (e.g., MP3 files, digital audio files, digital video files, etc). These electronic assets may be stored locally on an electronic device of the user, may be retrieved from the Internet, or may be stored on a remote computer system to which the user has access. In such an embodiment, any two or more digital devices should have the same graphical user interface, should display information in the same manner, and should manage electronic assets using a common management protocol, except where basic hardware characteristics force a difference.

In an embodiment, a graphical user interface is used to create, manage, display, share a variety of electronic assets through a uniform navigational protocol. Such electronic assets include, but are not limited to, documents (e.g., word processing documents, spreadsheets, presentations), email, web bookmarks, Internet content, information and messages from one or more social networking website, and multimedia files (e.g., MP3 files, digital audio files, digital video files, etc). These electronic assets may be stored locally on an electronic device of the user, may be retrieved from the Internet, or may be stored on a remote computer system to which the user has access

In an embodiment, the graphical user interface provides consumer and business users virtually seamless access across personal computers, mobile devices, set-top boxes, networked appliances, and Internet “cloud” applications.

In an embodiment, the graphical user interface unifies multiple accounts for including but not limited to email, instant messaging, voicemail, social networks, and Internet Protocol (IP) voice or video.

In an embodiment, the graphical user interface integrates social networking on the desktop. For example, updates from social networks can be posted from the graphical user interface, and postings from social networks by friends or groups can be viewed on the graphical user interface.

In an embodiment, the graphical user interface provides an integrated desktop and file system. Instead of two parallel storage spaces, a card deck of the graphical user interface is a single integrated storage space that treats all data objects uniformly. The upper levels of the card-deck can be managed automatically (e.g., through an algorithm that balances recently-used files and frequently-used files), and additionally or alternatively, semi-automatically by the user (e.g., who can “promote” any card to the desktop or replace it automatically in the hierarchy).

In an embodiment, the graphical user interface streams available content to a real-time desktop viewer. In such an embodiment, the graphical user interface can stream any combination of online content, content from a user's computer system, or content from a remote computer system accessible to the user. Further, the graphical user interface can stream visual alerts of incoming communications and media in a single streamer or any combination of streamers and additionally or alternatively, the graphical user interface can provide audible alerts of incoming communications and media.

In an embodiment, the graphical user interface allows a user to share a file or group of files from any application with any other individual or group of individuals, regardless of whether these individuals are users of the graphical user interface. In such an embodiment, no attachments or uploads are required. Users can send files or groups of files directly to an intended recipient via secure peer-to-peer connection. A notification of a received file or group of files is provided to recipient one or more streamers of the recipient's graphical user interface. In an embodiment, such streamers may display links to all electronic assets received in real time, or alternatively, streamers may display links to any electronic asset received in real-time from a particular set of senders, e.g., a set of “safe” senders. If a recipient is not a user of the graphical user interface, the recipient receives the file or groups of files as an email or file download, or alternatively, the user can download a fully- or partially-functional copy of the graphical user interface to leverage the inherent hierarchy of the shared files.

In an embodiment, the graphical user interface supports time-management via a universal click-ahead function and a universal click-back function. In an embodiment, the click-ahead functionality allows a user to transfer an email, document, calendar appointment, posting from a social network website, or other electronic asset to the future. Within such functionality, the “clicked-forward” assets are presented to the user of the graphical user interface in a streamer at the specified future time as a reminder, Further, the click-back functionality allows the user to transfer an email, document, calendar appointment, posting from a social network website, or other electronic asset from some point in the future to a present time, or additionally or alternatively, to any other time. The “clicked-back” assets are then be presented to the user of the graphical user interface in a streamer as a reminder. In an additional embodiment, such reminders of “clicked-forward” and “clicked-back” assets are continually streamed to the user until the user acknowledges the reminder.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A and 1B depict features of an exemplary graphical user interface, according to an embodiment of the present invention.

FIGS. 2A and 2B depict features of an exemplary graphical user interface, according to an additional embodiment of the present invention.

FIGS. 3A and 3B depict an exemplary process through which a user views information on electronic assets using a graphical user interface, according to an embodiment of the present invention.

FIGS. 3C and 3D depict an exemplary process through which a user views information on electronic assets using a graphical user interface, according to an additional embodiment of the present invention.

FIGS. 4A, 4B, and 4C depict an exemplary process through which a user views electronic assets using a graphical user interface, according to an embodiment of the present invention.

FIGS. 5A, 5B, 5C, and 5D are overhead views of steps of the exemplary process of FIGS. 4A, 4B, and 4C.

FIGS. 6 and 7 depict a plurality of asset-level cards viewed through a graphical user interface, according to an embodiment of the present invention.

FIGS. 8A, 8B, and 8C depict an exemplary process through which a user obtains information on electronic assets and views electronic assets using a graphical user interface, according to an embodiment of the present invention.

FIGS. 9A and 9B describe an exemplary process through which a user obtains information on an electronic asset using a graphical user interface, according to an embodiment of the present invention.

FIGS. 10A, 10B, 10C, and 10D depict exemplary processes through which a user views an electronic asset using a graphical user interface, according to embodiments of the present invention.

FIGS. 10E, 10F, and 10G depict exemplary processes through which a user manages multiple electronic assets using a graphical user interface, according to additional embodiments of the present invention.

FIG. 10H depicts an exemplary process through which a user manages an electronic asset using a graphical user interface, according to an additional embodiment of the present invention.

FIGS. 11A and 11B depict an exemplary process by which a user obtains information on an electronic asset using a graphical user interface, according to an embodiment of the present invention.

FIGS. 12A and 12B illustrate features of a system-level card incorporated within a graphical user interface, according to an embodiment of the present invention.

FIGS. 13A and 13B depict an exemplary proxy server that tracks user activity involving a graphical user interface, according to an embodiment of the present invention.

FIGS. 14A and 14B depict an exemplary activity monitor that tracks user activity involving a graphical user interface, according to an embodiment of the present invention.

FIGS. 15A and 15B depict a graphical user interface that delivers targeted advertising to a user, according to an embodiment of the present invention.

FIGS. 16A-16D depict an exemplary process by which users of a graphical user interface electronically share electronic assets, according to an embodiment of the present invention.

FIG. 17 depicts an exemplary process through which a user of a graphical user interface accesses an electronic “shopping mall,” according to an embodiment of the present invention.

FIG. 18 is an exemplary computer architecture upon which embodiments of the present invention may be implemented.

The features and advantages of the present invention will become more apparent from the detailed description set forth below when taken in conjunction with the drawings. In the drawings, like reference numbers generally indicate identical, functionally similar, and/or structurally similar elements.

### DESCRIPTION OF PREFERRED EMBODIMENTS

The present invention, as described below, may be implemented in many different embodiments of software, hardware, firmware, and the entities illustrated in the figures. Any actual software code with a specialized control of hardware to implement the present invention is not limiting to the present invention. Thus, the operational behavior of the present invention will be described with the understanding that modifications and variations of the embodiments are possible, given the level of detail presented herein.

### Operation of an Exemplary Graphical User Interface

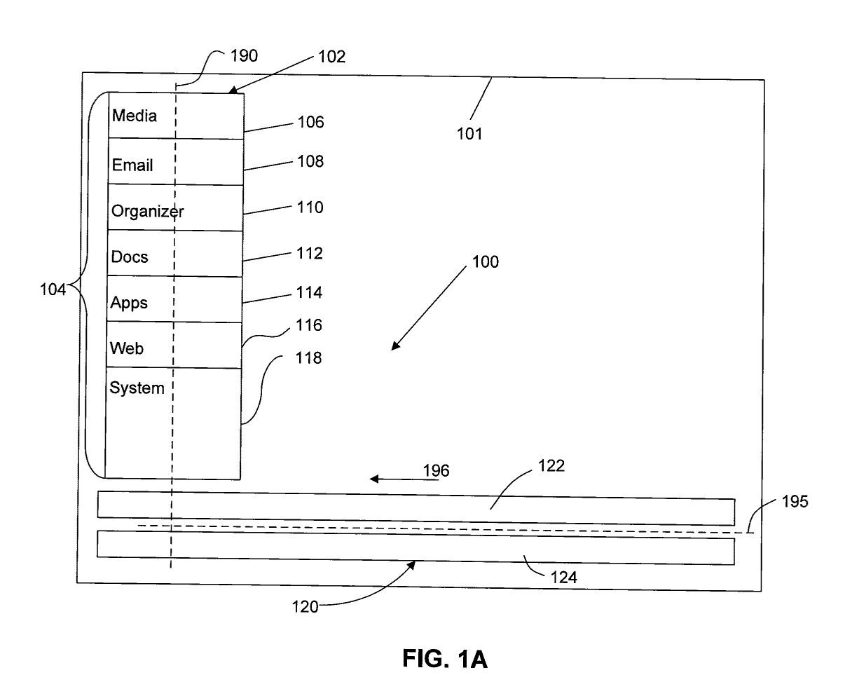

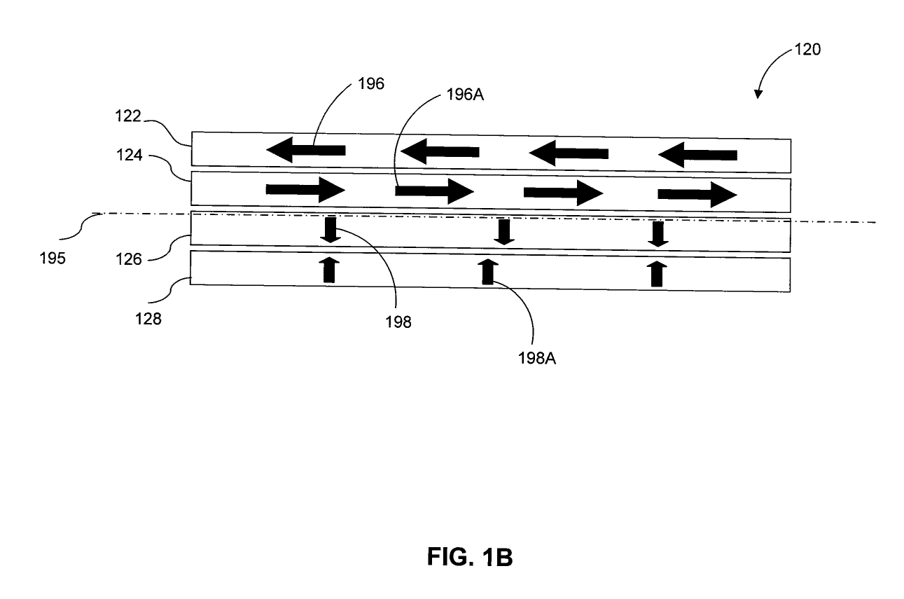

FIG. 1A depicts an exemplary graphical user interface (GUI) 100, according to an embodiment of the present invention. Graphical user interface 100 includes a bar 102 having one or more segmented geometric structures, shown generally at 104, and additionally or alternatively, a set of one or more elongated streamers, shown generally at 120. In FIG. 1A, graphical user interface 100 is configured such that an elongated axis 190 of bar 102 is positioned perpendicular to an elongated axis 195 of streamers 120, thereby forming an “L-shaped” interface. In such an embodiment, graphical user interface 100 may be viewed on a large screen display 101, including, but not limited to, displays characteristic of computer monitors, laptop computers, and televisions, such as those with “large screen” displays, high-definition (HD) displays, or combinations thereof. Further, in additional embodiments, graphical user interface 100 can be viewed on a screen or display characteristic of a remote control, a navigational device for a computer, such as a mouse, or any other device that would be apparent to one skilled in the art.

Each of the plurality of segmented geometric structures 104 takes the form of a “card” that is responsive to the actions of a user. In an embodiment, an individual card may serve as a manager of one or more electronic assets accessible to the user (e.g., assets stored within the user's computer system or located on or drawn from the Internet), including, but not limited to text documents, email messages, text and/or voice messages, “instant messages,” or any series of instant messages forming a dialogue or conversation, digital images, videos, tasks, appointments, information, updates, and messages from one or more social networking websites or services (including, but not limited to, MySpace.com and Facebook.com), advertisements, web sites, URLs, and one or more executable programs and objects.

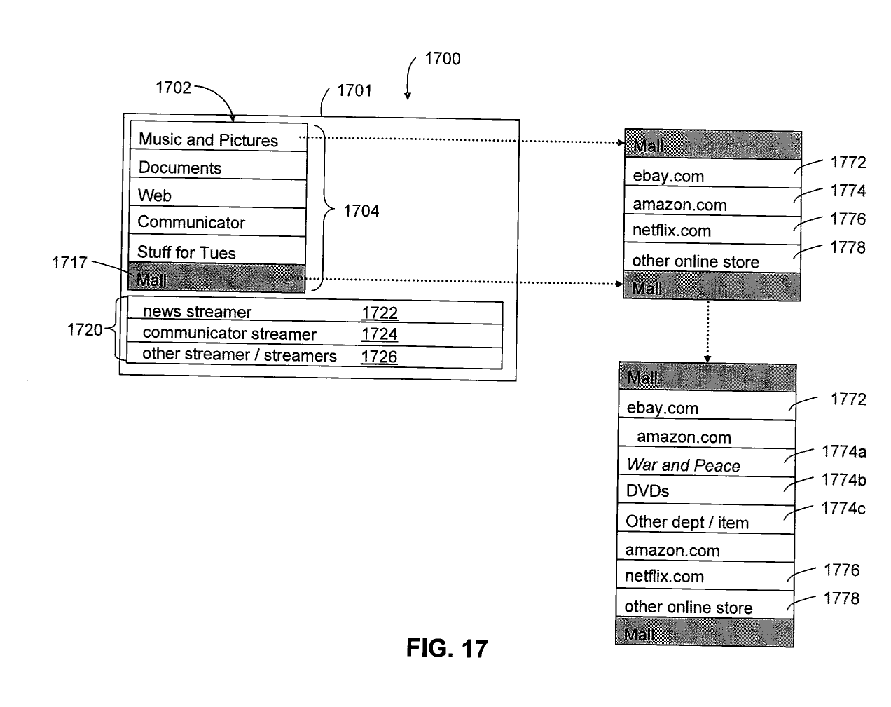

For example, an individual card may be a “group-level card” that manages an autonomous subset of one or more electronic assets (such autonomous subsets may or may not be disjoint), or alternatively, an individual card may be an “asset-level card” that manages a single electronic asset. For example, a group-level card may manage one or more additional cards that collectively form a “‘walk-in’ electronic shopping mall or one or more electronic shops,” as described in greater detail below with reference to FIG. 17.

However, the present invention is not limited to individual cards that manage electronic assets that are locally accessible to the user (i.e., stored on a user's computer system). In additional embodiments, one or more individual cards within bar 102 can manage electronic assets that are not locally-accessible to the user, including, but not limited to, electronic assets stored within off-site data repositories or on remotely-located computer systems to which the user has access.

The present invention, although described in terms of a bar having one or more segmented, geometric structures, is not limited to such configurations. In additional embodiments, a bar, deck, or card deck (e.g., bar 102 of FIG. 1A), may include a single geometric structure, or any appropriate combination of segmented geometric structures, without departing from the spirit or scope of the present invention.

In an embodiment, each electronic asset may be associated with, or linked to, an asset-level card, which may be further associated with, or linked to, one or more group-level cards. Further, a group-level card may be linked not only to one or more asset-level cards, but also to one or more “subgroup-level cards,” which are themselves linked, respectively, to one or more asset-level cards or additional subgroup-level cards. In such an embodiment, a group-level card may be linked directly to one or more electronic assets and to one or more groups of electronic assets, thereby creating a hierarchy of grouped and linked electronic assets. In the embodiments described herein, the hierarchy defined by group-level cards, subgroup-level cards, and asset-level cards may be arbitrarily deep and may be extended to any number or linking of asset-level cards, subgroup-level cards, and group-level cards without departing from the spirit or scope of the present invention.

The plurality of segmented, geometric structures 104 is not limited to rectangular cards that manage one or more electronic assets. In additional embodiments, an individual card may be a “system-level card” that manages the functionality of graphical user interface 100. In such an embodiment, the system-level card can directly manage a functionality of a computer system on which graphical user interface 100 operates (i.e., when graphical user interface 100 acts as an operating system), and additionally or alternatively, the system-level card can indirectly manage the functionality of the computer system (i.e., when graphical user interface 100 operates in conjunction with an operating system, such as Linux or Windows). For example, a system-level card may allow a user to search for any of a number of electronic assets stored within the computer system, to change the parameters of the display, or to attach or regulate one or more peripheral devices. Further, a system-level card may provide a user an opportunity to create a new group-level and asset-level card, and additionally, to share a group-level and/or asset-level card with another individual, whether or not that individual uses graphical user interface 100.

In the embodiment of FIG. 1A, bar 102 features a plurality of group-level cards that manage electronic assets, including a “Media” card 106, an “Email” card 108, an “Organizer” card 110, a “Docs” card 112, an “Apps” card 114, and a “Web” card 116. Further, bar 102 also features a system-level card 118. In FIG. 1A, only a portion of each group-level card is visible to the user, while the entire system-level card 118 is viewable by the user. However, the present invention is not limited to such configurations, and in additional embodiments, any portion of system level card 118 can be visible to the user, regardless of whether any other cards are visible to the user.

For example, Media card 106 may manage one or more electronic media assets, including, but not limited to digital images, videos, and music. Email card 108 and Organizer card 110 may manage one or more email messages stored on the system and organizer information, including, but not limited to, calendar information and tasks. Docs card 112 may manage one or more electronic documents stored on the system, such as word processing and spreadsheet documents. Apps card 114 may manage one or more executable programs and applications. Examples of such executable programs and applications include, but are not limited to, computer games and computer-aided drafting (CAD) applications.

For example, Web card 116 can link the user to one or more web sites, URLs, or bookmarks (e.g., web card 116 can act as a hyperlink to the web), and additionally or alternatively, web card 116 can be a group-level card that manages a set of asset level cards that act, respectively, as individual hyperlinks to the web. Further, in an embodiment, opening such an asset-level card can reveal a set of lower-level cards respectively linked to the opened asset-level card. In such an embodiment, each of the lower-level cards linked to the opened asset-level card can be respectively linked to a particular source of Internet content and respectively labeled according to that source (e.g., nested bookmarks-within-bookmarks are echoed by the hierarchy of the grouped and linked electronic assets).

Further, a link provided by Web card 116 may be directly linked to the source of Internet content or may be routed through a proxy server that tracks user activity and preserves user anonymity. Alternatively or additionally, such information can be accumulated by software running on the user's computer system. In an embodiment, Web card 116 supports an embedded web browser that allows the user to view online content without use of any third party web browser application (i.e., without explicitly executing, running or invoking a web browser application) and with bar 102 in full or partial view. Further, in additional embodiment, Web card 116 may deliver pre-selected or specified advertisements to a user, although other advertisements may appear on any level of any group-level card in bar 102 without departing from the spirit or scope of the present invention.

Cards within bar 102 may themselves be stored and indexed locally or remotely, in accordance with an embodiment of the present invention. In accordance with a further embodiment of the present invention, cards are stored within a cloud computing system. Additionally, the contents referenced by cards may themselves be stored and indexed within a cloud computing system, in accordance with an additional embodiment of the present invention. Furthermore, the indexed content may be part of a tagging system or process for purposes of easy searching and or data retrieval.

A user can specify which cards or what data referenced by cards is to be placed within the cloud computing system, in accordance with an embodiment of the present invention. By way of example, and not limitation, the system card 118 may implement an option which requests that one or more cards be synchronized to the cloud computing system, although one skilled in the relevant arts will appreciate that a number of means exist by which a user may specify what data to synchronize to the cloud computing system. Additionally, in accordance with a further embodiment of the present invention, some or all assets or cards can be organized by category or by the creation of an individual library or libraries for some or all assets or cards.

By using a cloud computing system as a remote storage device, a user may engage in place-shifting. For example, a user may have a set of photos on a personal computer. The user may wish to have access to these photos on the user's cell phone, or indeed any other device equipped with the GUI 100. The user may specify a card containing the photos for uploading to the cloud computing system, whereby the system will synchronize these photos. When accessing GUI 100 within the user's cell phone, the card will be retrieved from the cloud computing system and be presented to the user for viewing.

Additionally, in accordance with a further embodiment of the present invention, assets may be designated as “following” the user. Assets designated in this manner are made automatically available and status is maintained as the user moves from device to device. By way of example, and not limitation, a user who has configured bar 102 in a particular manner on his or her cellphone may access the same configuration on his or her laptop computer.

The orientation and disposition of the group of cards in FIG. 1A illustrates an exemplary, default layout that, in additional embodiments, may be modified without departing from the spirit or scope of the present invention. For example, the order in which the group of cards are arranged in bar 102 of FIG. 1A may be modified by the actions of a user, including, but not limited to, dragging and dropping respective cards within the group of cards into new positions within bar 104. In additional embodiments, the order in which group of cards are arranged may be responsive to the creation of new cards by the user or to the receipt of new content by graphical user interface 100.

In an embodiment, each group-level card in bar 102 may have a search function or an incremental search function that allows a user to search over all of the subgroup- and asset-level cards linked to the respective group-level card. In an embodiment, such a search may generate a new set of group-, subgroup-, and asset-level cards arranged into a corresponding bar, or alternatively or additionally, a new segment of an existing bar including only the search-relevant subset of subgroup- and asset-level cards associated with the respective group-level card being searched. A similar search function can operate at the global level, and such a search would thus restructure or rebuild the plurality of group-, subgroup-, and asset-level cards within the bar.

In various embodiments, the search function may return results using any ranking algorithm, including but not limited to one directed to relevancy, title, date of last use, and file type. In an embodiment, a bar having respective pluralities of group-, subgroup-, and asset-level cards obtained from a search may be saved and stored for later use. Further, the graphical user interface can include one or more fully-functional bars having respective pluralities of group-, subgroup- and asset-level cards, and the user may position one or more bars on a corresponding screen (e.g., display 101) by dragging it with the mouse or by performing any of a number of a number of operations apparent to one skilled in the art without departing from the spirit or scope of the present invention.

In accordance with an additional embodiment of the present invention, when a card is created or at some other point, a set of tags is automatically generated for the card. In accordance with another embodiment of the present invention, a user may be prompted to specify a set of tags for the card upon creation or at any other point. These tags describe the contents of the card using key terms.

In an embodiment, the search function described above is extended to allow searching of these tags, thereby enabling a user to rapidly retrieve tag-related cards in a single search. In accordance with another embodiment of the present invention, indexing is performed on tags and/or content associated with an asset card or group card. By way of example, and not limitation, one or more songs of a common genre, such as “Classic Rock”, may be tagged as such, enabling a user to search for this genre tag and retrieve all songs associated with this tag. In another non-limiting example, a word processing document may be tagged, enabling a user to search and retrieve the word processing document based on its associated tags.

In accordance with an additional embodiment of the present invention, cards may be published on or to the internet or to an enterprise network or any other network. Furthermore, in an additional embodiment of the present invention, when a card is published the card's tags and other metadata are published as well allowing for any number of searches to be performed among any group of said published cards. By way of example, and not limitation, a card representing a photograph asset, which is tagged as a particular photograph, is published to a web-site which contains a series of other published asset cards. A search is performed on the group of published asset cards for one or more tags attached to that particular card.

Further, the present invention is not limited to segmented, contiguous geometric objects in the form of rectangular cards. In an additional embodiment, segmented geometrical objects 104 may include one or more of a number of geometric shapes that would be apparent to one skilled in the art without departing from the spirit and scope of the present invention. Further, in an embodiment, the segmented geometrical objects 104 need not be attached, respectively, to one another (e.g., segmented geometrical objects 104 need not be contiguous). In such an embodiment, segmented geometrical objects 104 of bar 102 may be aligned horizontally rather than vertically (i.e., along any axis perpendicular to axis 190). Further, in additional embodiments, one or more objects of segmented geometrical objects 104 can be aligned along any combination of horizontal and vertical axes without departing from the spirit or scope of the present invention.

In an embodiment, the shape and size of a respective card, and a position of a respective card within a bar, e.g., bar 102, may change dynamically, such as in response to an action by a user or a system-level event, including, but not limited to, an arrival of new content. For example, a lower-level card can be relocated to the top of the bar, or elsewhere in the bar, in response to an action by the user or a system-level event. Such a relocated lower card can be returned to its place in the hierarchy with a single click or through any actionable input apparent to one skilled in the art, including, but not limited to, one or more keystrokes, a voice command, or the use of touch.

Graphical user interface 100 also includes a set of elongated streamers, shown generally at 120. In an embodiment, an elongated axis 195 of streamers 120 is positioned perpendicular to elongated axis 190 of bar 102, thereby forming the “L-shaped” interface. Streamers 120 continuously display data to a user as links, and the user may click on or hover over an embedded link to view a source of the data or other information. In an embodiment, such links include, but are not limited to, arbitrary pointers, addresses, and URLs that could, in various embodiments, refer to respective sources of Internet content, respective electronic assets on the user's own computer system, and a remote computer system. Further, the data associated with a respective embedded link and displayed by streamers 120 can include any combination of text and/or phrases relevant to the embedded link (or to the electronic asset or Internet content associated with the embedded link). However, such relevant text need not include a URL or a name of a web site or web page associated with the embedded link.

In an embodiment, streamers 120 may display any of a variety of content to a user, including, but not limited to any combination of: (i) targeted or other forms of advertising; (ii) links to the world-wide web; (iii) links to email messages stored on the user's computer system, email messages in real-time as received on the user's computer system, and summaries of email messages stored or received in any combination on the user's computer and one or more remotely-located computer systems to which the user has access; (iv) links to stored multi-media files; (v) links to stored documents, text messages, updates, images, and other information associated with a user's account on one or more social networking systems (e.g., Facebook.com or MySpace.com); (vi) video stored within the user's computer system or located on or drawn from the Internet; and (vii) any information associated with or linked to one or more cards in bar 102. Graphical user interface 100 may retrieve data using an appropriate web service, and the retrieved data may be processed to generate an appropriate interface, or wrapper, for the data when it is displayed to the user.

In an embodiment, the wrapper may include a title associated with the respective data, one or more pointers associated with the respective data, and additionally, a data type associated with the data. For example, title associated with the data may be displayed graphically on streamers 120. The pointer may, in various embodiments, indicate a location of an electronic asset on a computer system or a URL for an electronic asset located on the world-wide web. Further, for example, the data type may identify explicitly a type of the electronic asset (e.g., an image, video, MP3 etc.) or alternatively, the data type may implicitly identify the electronic asset.

In one embodiment, streamers 120 provide continuously-updated internet content, including, but not limited to, news headlines, items for sale from an online retailer, information of any type, bids received for one or more items for auction, or an electronic catalogue of items for sale, to the user of graphical user interface 100 without requiring the user to invoke a separate internet browser external to graphical user interface 100. For example, streamers 120 can provide continuously-updated internet content on books for sale at an online retailer, such as Amazon.com. In an embodiment, graphical user interface 100 may retrieve data from the world-wide web using an appropriate web service and process the data to generate a wrapper, as described above, that includes an embedded link to a source of the data. Continuously-evolving links may subsequently be displayed to a user by streamers 120, thereby allowing the user of the graphical user interface 100 to click on a link of interest, stop the streamer, and visit a source of the data.

The user may visit a source of the data through an embedded browser associated with graphical user interface 100, and the embedded browser may operate through a proxy server that may preserve the anonymity of the user during communications with the data source. The proxy server may also allow graphical user interface 100 to track the frequency and duration of internet usage, and additionally or alternatively, other information about the user. For example, the proxy server may track completed online transactions involving the user and transmit details of these completed online transactions, including, but not limited to, information on specific purchases at online retailers. Further, for example, the proxy server may track user click-through activity and any other information apparent to one skilled in the art. In such embodiments, the proxy server may communicate the captured information to one or more third parties, including, but not limited to, online retailers and online advertisers, and in additional embodiments, these third parties may target advertisements and online content to the user based on the captured information.

In an additional embodiment, graphical user interface 100 may incorporate any additional tracking technology apparent to one skilled in the art and capable of capturing the desired information. Further, the additional tracking technology may be implemented into graphical user interface 100 to supplement or, alternatively, to replace the tracking capability of the proxy server. For example, graphical user interface 100 may incorporate an activity monitor coupled to a background process, or daemon, to collect information on user activity and transmit the collected data to the proxy server, which may subsequently transmit any portion of the collected data to one or more third parties.

Further, in an additional embodiment, a user may visit a source of the data through a web browser that does not protect the anonymity of the user, such as Mozilla Firefox or Microsoft Internet Explorer. In such an embodiment, the online activity of the user may be or need not be tracked by the proxy server, or alternatively, the online activity of the user may be tracked by the additional tracking technology described above. Further, in additional embodiments, graphical user interface 100 may permit the user to access only specified online content through the web browser, while routing other online content through the proxy server.

In additional embodiments, streamers 120 provide links to additional electronic assets stored locally on the computer system, including, but not limited to, email messages, digital images, calendar appointments, videos (e.g., MPEG files, etc.), digital music (e.g., MP3 files), or any additional electronic asset not linked to the world-wide web. In these embodiments, such additional electronic assets (e.g., email messages, calendar appointments, etc.) may not be “files” in a traditional sense and as such, may not be generally represented within file systems characteristic of many operating systems, including, but not limited to Microsoft Windows. For example, graphical user interface 100 may retrieve email messages stored locally on the computer system, and a title and/or other identifying information of each respective email system may be displayed continuously across streamers 120. In such an embodiment, a user may click on an individual email message of interest, and the selected email message would then open using a default email client associated with the computer system. In another embodiment, graphical user interface 100 may cache and display email thereby allowing the user to view such emails without explicitly opening any email client or separate application. Further, graphical user interface 100 may also allow the user to compose and transmit email messages without explicitly opening any email client or separate application.

However, the present invention is not limited to streamers, such as streamers 120, that display links to links to electronic assets stored locally on the computer system of the user. In additional embodiments, one or more streamers can display links to electronic assets that are not locally-stored on the user's computer system, including, but not limited to, electronic assets stored within off-site data repositories or within remotely-located computer systems to which the user has access.

In an additional embodiment, a user may hover over a streamer item to obtain a synopsis of that item. For example, the user may hover over an email item, thereby displaying a portion of the email, including but not limited to one or more lines of the email, a subject line of the email, or the email message in its entirety. Further, for example, hovering over a song title may cause the first few seconds of that song to be played. In additional embodiments, the synopsis of the streamer item can include any multimedia summary or description of the streamer item that would be apparent to one skilled in the art.

In an additional embodiment, a user may indicate that a stored electronic asset, including, but not limited to an email message, file, task, or calendar appointment, should be “time shifted” into the future for action at a later time, and streamers 120 may display continuously or during an appropriate “alert” period such time-shifted electronic assets as reminders to the user. For example, the user may indicate that a stored electronic asset, which is relevant to a current date or time, be shifted forward in time to serve as a reminder for future action at the later time. However, the present invention is not limited to time-shifting electronic assets relevant to a current date or time. In additional embodiments, the user may shift forward an electronic asset relevant to any past time period to serve as a reminder for future action, and additionally or alternatively, the user may shift an electronic asset back in time (for example, to make a group of documents complete or to add a newly-received bill or receipt to the group of documents in the past that collectively describe, e.g., a business trip).

In an embodiment, streamers 120 can also provide links to electronic assets, such as emails, text messages, or calendar appointments, that are received in real-time and have not yet been locally stored on a user's own computer system. For example, streamer 120 may display links to all electronic assets received in real time, or alternatively, streamers may display links to any electronic asset received in real-time from a particular set of senders, e.g., a set of “safe” senders. In an embodiment, the set of “safe” senders may be specified and periodically updated by the user, and set of “safe” senders may include any combination of individual senders and groups of senders associated with particular organizations or IP addresses.

In FIG. 1A, streamers 120 include a first streamer 122 and a second streamer 124, which, in an embodiment, respectively stream different types of data to the user. For example, first streamers 122 may be configured to display links to world-wide web content, including, but not limited to, internet content related to news, sports, stock market data, advertisements, auctions, and any combination of items sold by an online retailer (e.g., books, audio compact disks; DVDs, clothing, or any other items sold by Amazon.com). Further, first streamer 122 may be configured to display exclusive content from a particular source of world-wide web content that, in an additional embodiment, may purchase or otherwise secure rights to display exclusive content. Further, for example, second streamer 124 may be configured to display words or phrases associated with links to world-wide web content, links to remote computer system which the user has access, or links to electronic assets stored on the user's computer, including, but not limited to email messages, appointments, tasks, text or voice mail messages, digital images, videos, and documents.

For example, such world-wide web content can include structured data (e.g., extensible markup language (XML)) retrieved via the world-wide web using defined protocols. In additional embodiments, such structured data may be retrieved from a portion of a particular web site, portions of multiple web sites, or any other source of world-wide web content apparent to one skilled in the art without departing from the spirit and scope of the present invention.

In one embodiment, the streamed links may move along respective streamers 122 and 124 in a direction 196, although in additional embodiments, the streamed links of respective streamers 122 and 124 may proceed in a direction opposite direction 196. For example, in an embodiment, the streamed links may proceed in a direction different from, but not opposite to, direction 196, e.g., a direction perpendicular to direction 196. Further, the motion of the streamed links may be temporarily halted when the user clicks on or hovers over a particular link.

FIG. 1B depicts a set of streamers 120 that may be incorporated into the exemplary graphical user interface of FIG. 1A, according to an embodiment of the present invention. In FIG. 1B, set of streamers 120 includes a first streamer 122, a second streamer 124, a third streamer 126, and a fourth streamer 128 that area arranged mutually parallel to an elongated axis 195. As described above in reference to FIG. 1A, streamers 120 continuously display data to a user as links, and the user may click on or hover over an embedded link to view a source of the data or other information.

In the embodiment of FIG. 1B, streamed links move along first streamer 122 in a direction 196 that is substantially parallel to elongated axis 195, and streamed links move along second streamer 124 is a direction 196A that is substantially parallel to elongated axis 195, but opposite of direction 196. However, and as described above, the present invention is not limited to streamed links that move along respective streamers in a directions substantially parallel to elongated axis 195. In the embodiment of FIG. 1B, streamed links move along third streamer 126 in a direction 198 that is substantially perpendicular to elongated axis 195, and streamed links move along fourth streamer 128 in a direction 198A that is also substantially perpendicular to elongated axis 195, but also opposite to direction 198.

In additional embodiments, streamed links can move along the respective streamers (e.g., streamers 120 of FIGS. 1A and 1B) in any direction parallel to an elongated axis of the streamers, perpendicular to an elongated axis of the streamers, or along any direction apparent to one skilled in the art without departing from the spirit or scope of the present invention. Additionally, streamers 120 can incorporate any combination of individual streamers arranged substantially perpendicular to an elongated axis 190 of bar 102, arranged substantially parallel to elongated axis 190 of bar 102, or arranged such that elongated axes of respective streamers are positioned at any angle with respect to elongated axis 190 of bar 102 without departing from the spirit or scope of the present invention.

In additional embodiments, streamers 120, as depicted in FIGS. 1A and 1B, may include a single streamer, or alternatively, any arbitrary number of streamers, without departing from the spirit or scope of the present invention. In such an embodiment, the streamers may, respectively, be configured to display specific types of content or content from various sources. For example, each streamer of streamers may be configured to display Internet content from a different provider except for a final streamer, which may be configured to display links to locally-stored and/or remotely-stored electronic assets. In an additional embodiment, the one or more streamers may display any combination of content from any of a number of sources, which would be apparent to one skilled in the art. Further, the user or the system may combine one or more streamers into a single streamer through configurable settings or through interface techniques, including, but not limited to, dragging and dropping.

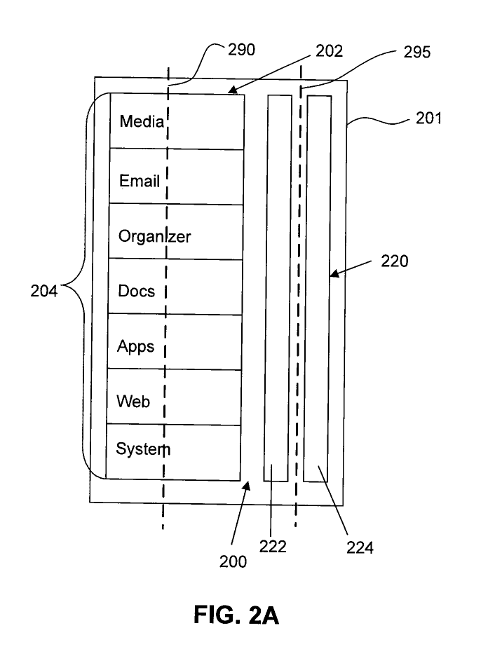

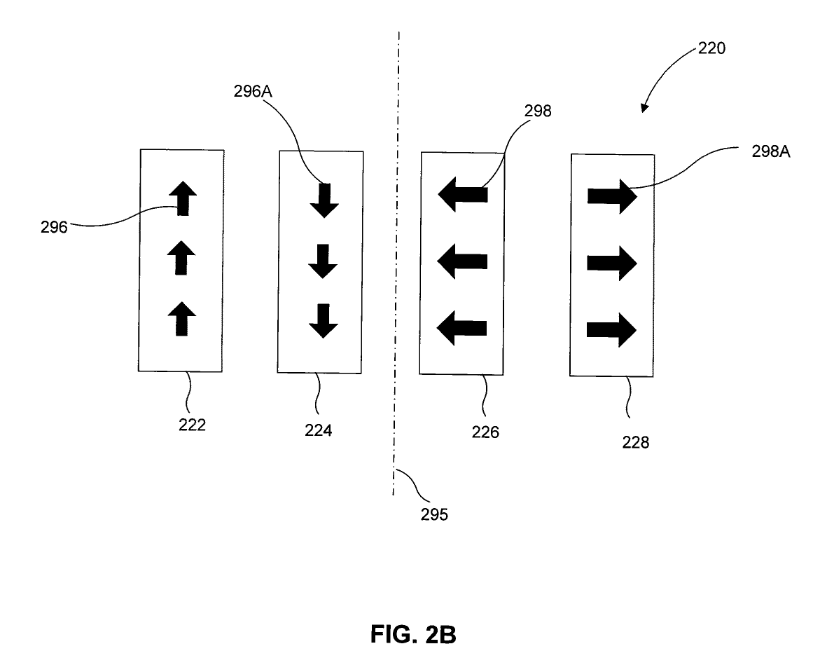

FIG. 2A depicts an exemplary graphical user interface (GUI) 200, according to an additional embodiment of the present invention. Graphical user interface 200 includes a bar 202 having a plurality of segmented geometric structures, or cards, shown generally at 204, and a set of elongated streamers, shown generally at 220, includes first streamer 222 and second streamer 224. Bar 202, the plurality of segmented geometric structures 204, and streamers 220 respectively function similarly to the corresponding components described above with respect to the graphical user interface of FIG. 1A.

However, in contrast to the graphical user interface of FIG. 1A, elongated bar 202 and streamers 220 are configured such that an elongated axis 290 of bar 202 is parallel to the elongated axis 295 of streamers 220. Further, in the embodiment of FIG. 2A, the dimensions of bar 202 and streamers 220 may be smaller than the dimensions of the corresponding structures FIG. 1A, and as such, graphical user interface 200 may be displayed on a substantially smaller screen that would be required by the graphical user interface of FIG. 1A. In one embodiment, graphical user interface 200 may be displayed on a screen, such as screen 201, of a cellular telephone, a personal digital assistant (PDA), or a “smart phone.” In additional embodiments, graphical user interface 200 may be displayed on a screen of a remote control, television, navigational device for a computer, such as a mouse, or any other device that would be apparent to one skilled in the art.

FIG. 2B depicts a set of streamers 220 that can be incorporated into the exemplary graphical interface of FIG. 2A, according to an embodiment of the present invention. As depicted in FIG. 2B, streamers 220 can include any number of individual streamers apparent to one skilled in the art, including, but not limited to, first streamer 222, second streamer 224, third streamer 226, and fourth streamer 228. Further, in an embodiment, streamed links may move along respective streamers 222, 224, 226, and 228 in any single direction or alternatively, in any combination of directions substantially parallel to elongated axis 295 of streamers 220 and substantially perpendicular to elongated axis 295 of streamers 220. In an additional embodiment, a user may specify a speed at which each of the one or more streamers operates. For example, the user may specify an identical speed for each of the one or more streamers, or alternatively, the user may specify different speeds for the one or more streamers.

For example, streamed links move along first streamer 222 in a direction 296 that is substantially parallel to elongated axis 295, and streamed links move along second streamer 224 is a direction 296A that is substantially parallel to elongated axis 195, but opposite of direction 296. Further, streamed links move along third streamer 226 in a direction 298 that is substantially perpendicular to elongated axis 295, and streamed links move along fourth streamer 228 in a direction 298A that is also substantially perpendicular to elongated axis 295, but also opposite to direction 298. Further, in additional embodiments, streamed links can move along the respective streamers in any direction parallel to an elongated axis of the streamers, perpendicular to an elongated axis of the streamers, or along any direction apparent to one skilled in the art without departing from the spirit or scope of the present invention.

In the embodiments described above, the graphical user interfaces of FIGS. 1A and 2A respectively include a bar of segmented geometric structures (e.g., bar 102 of FIG. 1A and bar 202 of FIG. 2A) and a set of streamers (e.g., streamers 120 of FIG. 1A and streamers 220 of FIG. 2A). However, the present invention is not limited to graphical user interfaces that include both a bar of segmented geometric structures and a set of streamers. In additional embodiments, the graphical user interfaces of FIGS. 1A and 2A (e.g., graphical user interface 100 of FIG. 1A and graphical user interface 200 of FIG. 2A) can include a set of streamers without a bar of segmented geometric structures, or alternatively, a bar of segmented geometric structures without streamers, without departing from the spirit or scope of the present invention.

A user of the exemplary graphical user interfaces of FIGS. 1A and 2A may access a segmented geometric structure, or card, by providing a particular input to the graphical user interface, including, but not limited to, one or more keystrokes, an action by a mouse, one or more digitized, verbal commands, or a use of touch. For example, the user may access summaries of those electronic assets associated with a particular card by positioning a mouse pointer over one or more regions of the card. However, the user may obtain access to the electronic asset itself by positioning the mouse pointer over the one or more regions of the card and clicking.

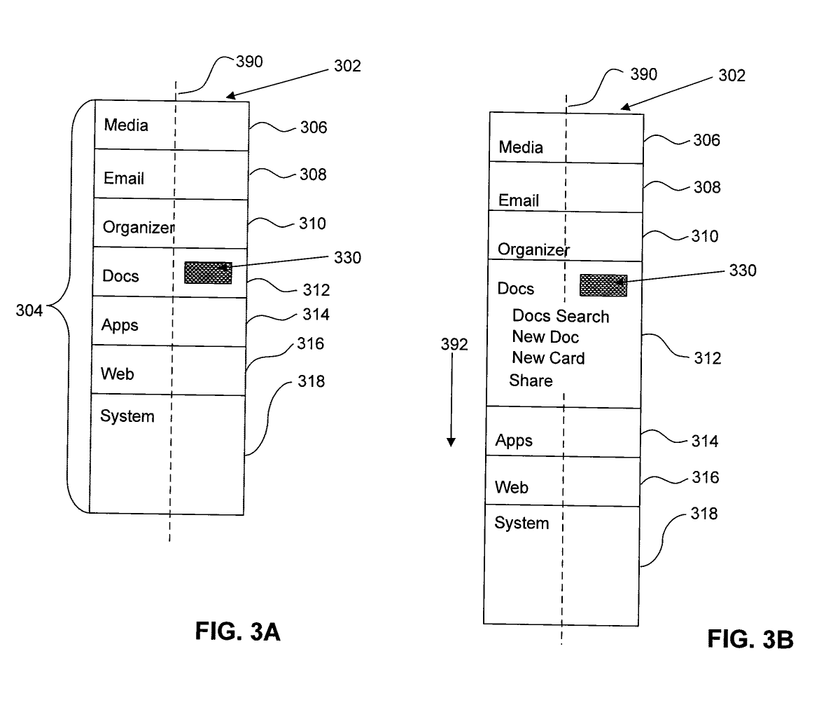

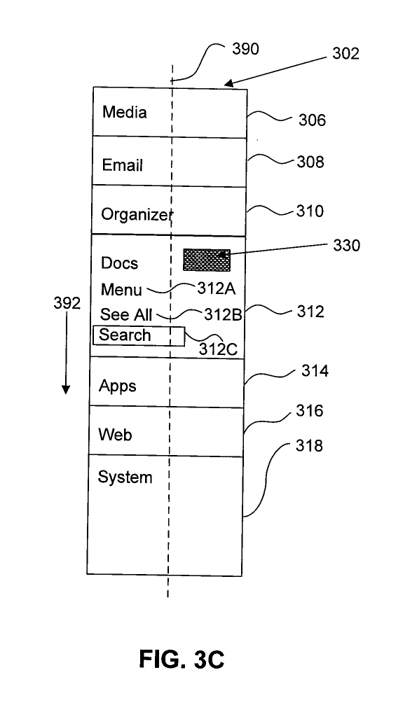

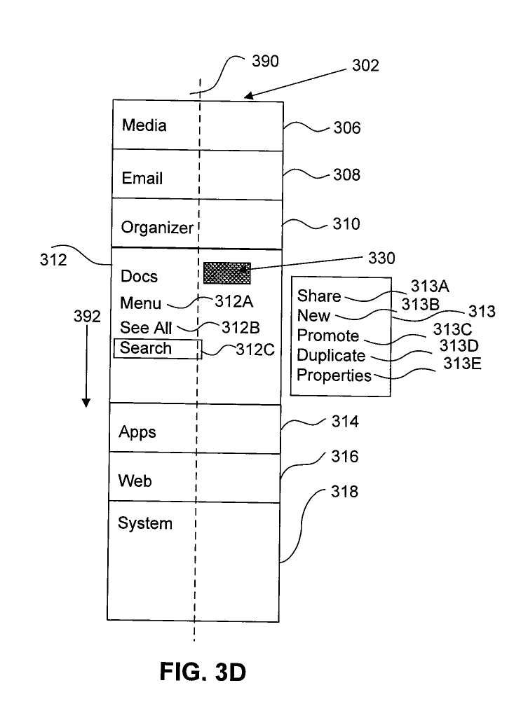

FIGS. 3A and 3B depict, respectively, an exemplary process by which a user views information on electronic assets associated with a group-level card, according to an embodiment of the invention. FIG. 3A depicts a bar 302 of a graphical user interface having a plurality of group-level cards, shown generally at 304, that are linked, respectively, to electronic assets of a user. For example, and as described above, a group-level Docs card 312 may be linked to one or more electronic assets stored on a computer system of the user (e.g., text files or word processing files). Further, as described above, only a portion of the contents associated with card 312 is visible to a user.

In the embodiment of FIG. 3A, the user may access additional information on the electronic assets associated with card 312 by positioning a mouse pointer over a region 330 of card 312 (hereinafter referred to as a “hover region”). Once the mouse pointer is positioned over hover region 330, card 312 expands along an elongated axis 390 of bar 302, or in any additional direction that would be apparent to one skilled in the art, to provide additional information on the electronic assets linked to card 312, as depicted in FIG. 3B. In FIG. 3A, the hover region is defined as a subset of card 312. However, the present invention is not limited to such hover regions, and in additional embodiments, the hover region may incorporate any portion of card 312 that would be apparent to one skilled in the art, including the entire surface of card 312.

In FIG. 3B, card 312 has expanded to display a number of actions available to the user to manage electronic assets associated with card 312. In the embodiment of FIG. 3B, the additional information allows the user to search for documents linked to group-level card 312 (e.g., through the “Docs Search” option). The user may also generate a new document using a native application (e.g., a new word processing document generated with a native word processing application). Additionally, the user may generate a new asset-level card linked to an electronic asset on the computer system that, in turn, would be linked directly to a group-level card (or to a previously-generated subgroup-level card). Further, the user may choose to generate a new subgroup-level card linked to card 312 and once generated, the user may link asset-level cards to the new subgroup-level card.

In addition, the user may choose to electronically share card 312, and therefore, all asset-level and subgroup-level cards linked to card 312, with an individual, regardless of whether that individual uses the graphical user interface of the present invention. In an embodiment, and unlike email attachments, such electronically-shared cards are constructed by users who periodically link electronic assets to the shared card or cards by dragging and releasing electronic assets, including asset-level cards and subgroup-level cards, onto shared cards. In additional embodiments, electronic assets, including asset-level cards and subgroup-level cards, can be linked to the shared card or cards through any additional action apparent to one skilled in the art, such as the use of voice, the use of touch, or combinations thereof, without departing from the spirit or scope of the present invention.

Further, in an embodiment, shared card 312 may refer to or be linked to a single electronic asset, or alternatively, shared card 312 may refer to or be linked to a collection of electronic assets that has been constructed automatically by the system. For example, by sharing Document Card 330 in FIG. 3A, the user shares all electronic assets associated with this card, e.g., all electronic assets that are ordinarily referred to as “documents.”

In FIG. 3B, card 312 expands along the elongated axis 390 of bar 302. In such an embodiment, the dimensions of the unselected cards of bar 302 (e.g., cards 306, 308, 310, 314, 316, and 318) remain unchanged, and the portion of these cards visible to the user also remains unchanged. Further, those cards positioned below card 312 (e.g., cards 314, 316, and 318) translate along elongated axis 390 in direction 392 as card 312 expands, while those cards positioned above card 312 (e.g., 306, 308, and 310) remain stationary.

In an additional embodiment, card 312 expands along elongated axis 390 in the direction opposite direction 392. As such, cards positioned above card 312 (e.g., cards 314, 316, and 318) translate along elongated axis 390 as card 312 expands, while those cards positioned below card 312 (e.g., 314, 316, and 318) remain stationary. In yet another embodiment, card 312 expands in both directions along elongated axis 390, and as such, both cards positioned above and below card 312 translate along elongated axis 390 as card 312 expands.

FIGS. 3C and 3D depict, respectively, details of an exemplary process through which a user views information on electronic assets associated with a group-level card, according to an additional embodiment of the invention. As described above in reference to FIGS. 3A and 3B, card 312 has expanded to display a number of actions available to a user to manage electronic assets associated with card 312.

For example, the user may search for documents linked to expanded group-level card 312. However, in contrast to the embodiment of FIG. 3B, the user initiates the search by entering a combination of a free-form or Boolean search query into a text box 312C. In an embodiment, the search query may be entered using a combination of keystrokes, using voice, or using any other appropriate technique apparent to one skilled in the art.

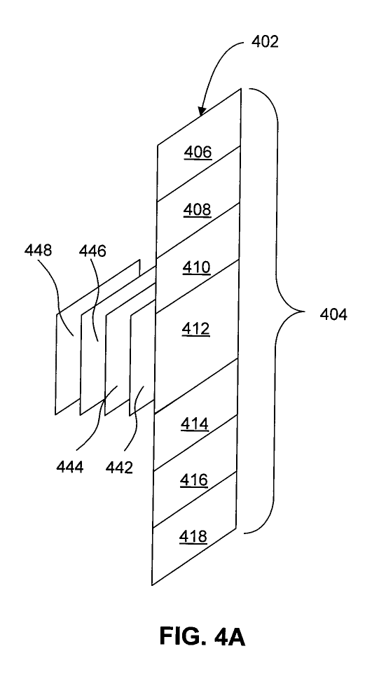

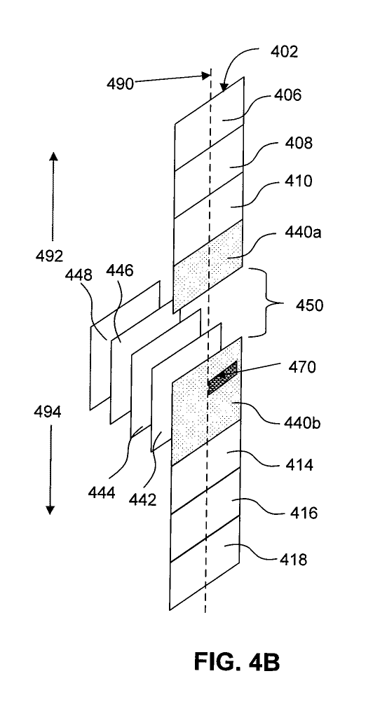

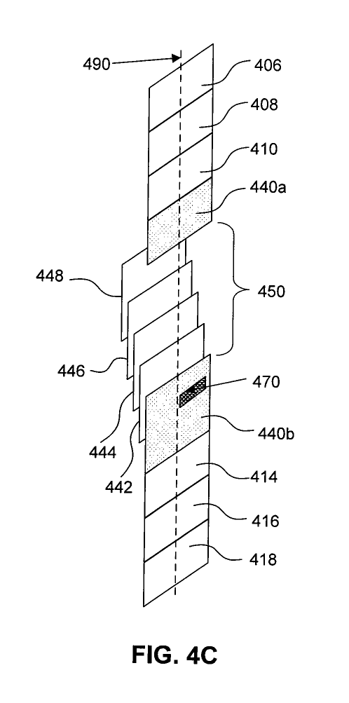

The user may also view a portion of any asset-level cards and subgroup-level cards linked to expanded card 312 by clicking on, hovering over, or otherwise activating a “See All” region 312B. Once the user activates See All region 312B, expanded card 312 may split into a header and footer card, thereby forming an expansion zone that displays a portion of each asset-level card and subgroup-level card linked to expanded card 312, as described below in reference to FIGS. 4A, 4B, and 4C.

Further, the user may manage expanded card 312, and any asset-level cards and subgroup-level cards linked to expanded card 312, by clicking on, hovering over, or otherwise activating a “Menu” region 312A of expanded card 312. In such an embodiment, as depicted in FIG. 3D, an additional Menu bar 313 may be generated and may be positioned proximate to expanded card 312. However, in additional embodiments, Menu bar 313 may be positioned over any part of expanded card 312, or any additional portion of bar 302, without departing from the spirit or scope of the present invention

In FIG. 3D, the user may activate individual regions within Menu bar 1087, including a “Share” region 313A, a “New” region 313B, a “Promote” region 313C, a “Duplicate” region 313D, and a “Properties” region 312E, by clicking within the region, hovering over the region, or otherwise activating the region, e.g., through a use of touch, voice, or other action. For example, the user may activate Share region 313A to electronically share expanded card 312 with an individual, and therefore, all asset-level and subgroup-level cards linked to expanded card 312, regardless of whether that individual uses the graphical user interface of the present invention.

Further, by clicking on, hovering over, or otherwise activating “New” region 313B, the user can generate a new asset-level card linked to expanded card 312 and additionally or alternatively, a new subgroup-level card linked to expanded card 312. The user can also click on, hover over, or otherwise activate “Promote” region 313C to promote the expanded card 312 to a higher position or the very top level of the card deck. The user could click on, hover over, or otherwise activate “Duplicate” region 313D to produce an identical copy of expanded card 312, including any asset-level and subgroup-level cards linked to the duplicated card. Further, by clicking on, hovering over, or otherwise activating “Properties” region 313E, the user may obtain additional details about card 312 and any electronic assets linked to card 312.

In the embodiments of FIGS. 3C and 3D, the additional functionality of text box 312C, See All region 312B, and Menu region 312 are associated with group-level Docs card 312. However, the present invention is not limited to such configurations, and in additional embodiments, the additional functionalities described in FIGS. 3C and 3D can be applied to any additional group-level card in bar 302 (e.g., cards 306, 308, 310, 314, 316, and 318), any subgroup-level card linked to a group-level card in bar 302, and any asset-level card linked to a group-level or subgroup-level card in bar 302 without departing from the spirit or scope of the present invention.

As described above, a user may also access one or more electronic assets associated with a group-level card by clicking on one or more regions of the card. FIGS. 4A, 4B, and 4C are cross-sectional views of an exemplary process by which a user accesses electronic assets associated with a group-level card, according to an embodiment of the invention. In FIG. 4A, a bar 402 of a graphical user interface includes a plurality of group-level cards, shown generally at 404 and corresponding to the plurality of group-level cards depicted in FIG. 3. As described above, each of the plurality of cards may be associated with one or more additional asset-level cards, thereby establishing a hierarchy of linked cards associated with each group-level card.

For example, group-level card 412 is linked to lower-level cards 442, 444, 446, and 448. In the embodiment of FIGS. 4A-4C, lower-level cards 442, 444, 446, and 448 are, respectively, asset-level cards linked to a corresponding electronic asset, including, but not limited to, a text document, a spreadsheet, an email message, MP3, or a digital image or movie. In additional embodiment, not shown, one or more of lower-level cards 442, 444, 446, and 448 can be a subgroup-level card, which in turn may be linked, respectively, to one or more asset-level cards.

In FIG. 4B, the user positions a mouse pointer over a region 470 of card 412 (hereinafter referred to as a “click region”) and clicks within click region 470 to expose asset-level cards 442, 444, 446, and 448. Upon clicking, card 412 splits into header cards 440a and 440b, and an expansion zone 450 forms and expands between header card 440a and 440b, as depicted in FIG. 4B. During the expansion, both header card 440a and the cards positioned above header card 440a (e.g., cards 406, 408, and 410) remain stationary, while header card 440b and those cards positioned below header card 440b (e.g., cards 414, 416, and 418) translate along elongated axis 490 in direction 494. In additional embodiments, header card 440a and the cards positioned above header card 440a translate along elongated axis 490 in direction 492 during the expansion process, and additionally or alternatively, header card 440b and those cards positioned below header card 440b can remain stationary.

However, the present invention is not limited to the process depicted in FIGS. 4A and 4B, in which card 412 splits into two header cards. In additional embodiments, the clicked card, e.g., card 412, can slide along axis 490 to reveal any of the one or more cards (e.g., cards 442, 444, 446, and 448) linked to card 412 and to reveal a final header card. In additional embodiments, the final header card may or may not have the same appearance and function as card 412.

As depicted in FIG. 4C, once the expansion process is complete, a portion of each of asset-level cards 442, 444, 446, and 448 is visible to the user within an expansion zone 450, which is bracketed by header cards 440a and 440b. Further, each of the asset-level cards 442, 444, 446, and 448 may be responsive to the actions of the user, including, but not limited to, both hovering and clicking actions. In addition, the dimensions of the unselected cards (e.g., cards 406, 408, 410, 414, 416, and 418) are not affected by their translation along elongated axis 490, and the portion of these cards visible to the user remains unchanged. Further, the functionality of these additional cards remains unaffected by their translation along elongated axis 490, as each group-level card is still responsive to hovering and clicking by the user, and each bottom-level card, or leaf node, is similarly unaffected.

In an additional embodiment, bar 402 may include any number of individual cards, including, but not limited to those described above in reference to FIGS. 3A-3D. In such an embodiment, the translation of the unselected cards along elongated axis 490 may push one or more cards off the display screen, as the dimensions of the unselected cards remained unchanged during translation. In such an embodiment, a scroll bar (not shown), may be placed at an edge of bar 402 proximate cards 406 or 418, thereby enabling the user to scroll through those group-level cards pushed off the screen. Further, scrolling may be accomplished by means of “invisible scroll zones” activated by mouse hover at the top and bottom of the visible bar area, which relate the speed of scrolling to the position of the mouse relative to the top or bottom of the scroll area or using any actionable input apparent to one skilled in the art, including, but not limited to, one or more keystrokes, a voice command, or the use of touch. In an additional embodiment, any scroll bar can be replaced by a floating dot, or other floating image, that can be dragged up or down to actuate scrolling. In such an embodiment, a position of the floating dot or image on the screen relates to a position of the cards pushed off the screen and, additionally or alternatively, a portion of the bar being scrolled through on the screen

The user, after viewing those asset-level cards associated with card 412 (and potentially viewing the electronic assets respectively linked to the asset-level cards), may wish to hide asset-level cards 442, 444, 446, and 448. In such an embodiment, the user may re-position the mouse over click region 470 of header card 440a and may click again within click region 470 to collapse expansion zone 450 and return bar 402 to its the initial configuration, as depicted in FIG. 4A. In such an embodiment, the unaffected cards translate along elongated axis 490 to their initial positions, and header cards 440a and 440b rejoin to form group-level card 412, which is responsive to both hovering and clicking by the user. In additional embodiments, expansion zone 450 may be collapsed and bar 402 may be returned to its initial configuration in response to a period of inactivity of the user, and additionally or alternatively, in response to the user clicking on, hovering over, or otherwise actuating any additional or alternate region within the graphical user interface.

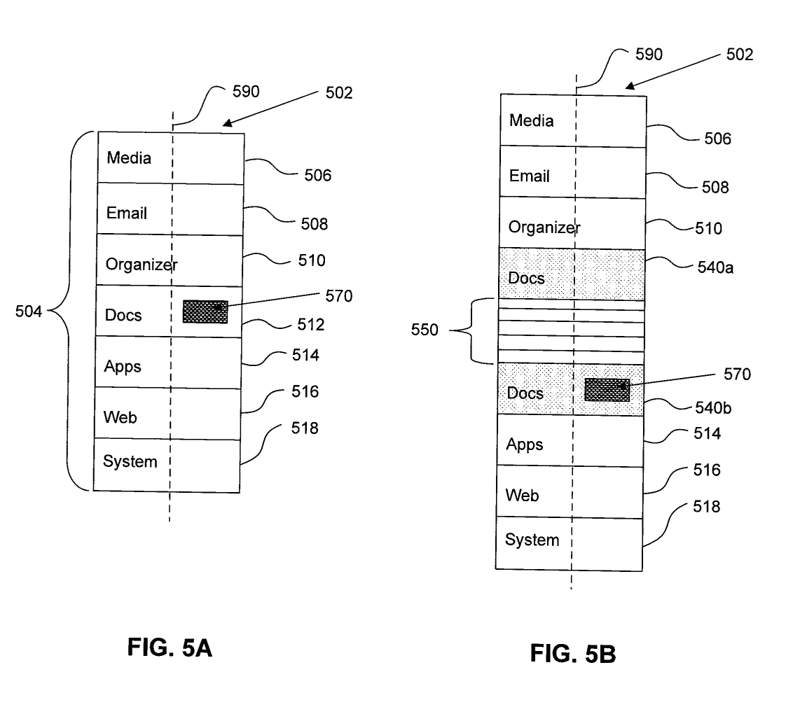

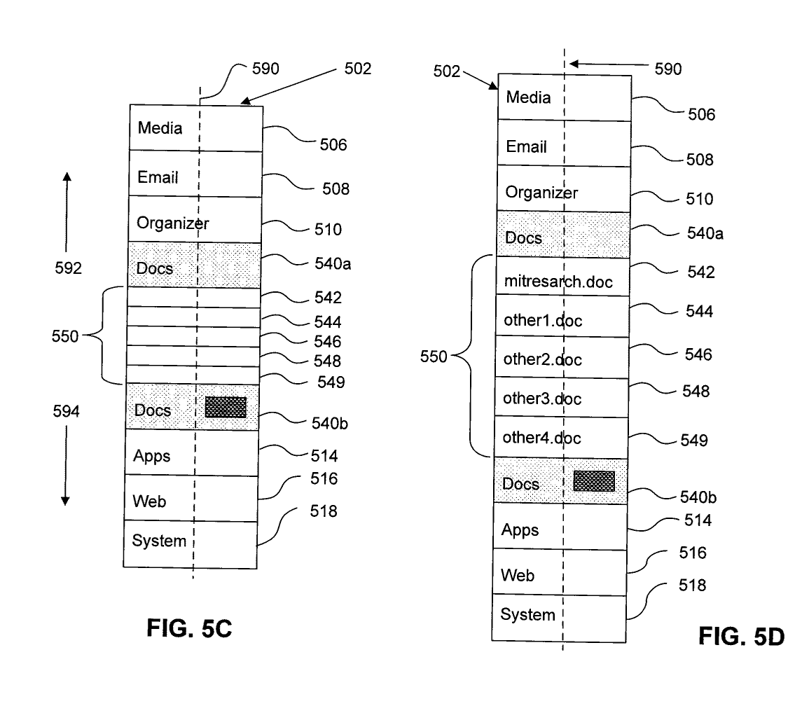

FIGS. 5A-5D are overhead views of the exemplary process depicted in FIGS. 4A-4C. In FIG. 5A, a bar 502 includes a plurality of group-level cards 504 that, respectively, manage one or more electronic assets. As described above with reference to FIG. 3, group-level cards 504 include a Media card 506, an Email card 508, an Organizer card 510, a Docs card 512, an Apps card 514, a Web card 516, and a system-level card 518. The present invention is not limited to the cards described above, and in additional embodiments, bar 502 may feature any variety and number of additional or alternative cards for managing electronic assets, including, but not limited to, one or more cards associated with a dedicated electronic or online retailer, one or more cards that form an electronic shopping mall, one or more cards associated with a social networking website, and a communicator card for emails and other forms of electronic communication, such as instant messages.

In FIG. 5A, a user has positioned a mouse pointer over a click region 570 of card 512, and upon clicking within click region 570, one or more asset-level cards (or subgroup-level cards) are exposed to the user, as depicted in FIGS. 5B and 5C. Upon clicking, an expansion zone 550 forms and expands in size between card 512 and adjacent card 514, as depicted in FIG. 5B. Further, in FIG. 5C, card 512 splits into header cards 540a and 540b that, respectively, bracket expansion zone 550. During the expansion of zone 550, header card 540a and those cards above header card 540a (e.g., card 506, 508, and 510) translate along an elongated axis 590 of bar 502 in a direction 592. In a similar fashion, header card 540b and those cards below header card 540b (e.g., cards 514, 516, and 518) translate along elongated axis 590 of bar 502 in a direction 594. As depicted in FIGS. 5B and 5C, expansion zone 550 forms and expands in size between header cards 540a and 504b, and those asset-level cards linked to card 512 fan out and are exposed to the user within expansion zone 550.

In an embodiment, asset-level cards linked to card 512 gradually fan out within expansion zone 550 as header cards 540a and 540 gradually separate (e.g., in a manner similar to theater curtains being drawn open). However, in additional embodiments, asset-level cards linked to card 512 can rapidly fan out within expansion zone 550 to instantaneously assume an exposed position within expansion zone 550, or, alternatively, asset-level cards linked to card 512 may proceed to an exposed position within expansion zone 550 in any recognizable manner without departing from the spirit or scope of the present invention.

Once the expansion process depicted in FIGS. 5B and 5C is completed, the user can view a portion of asset-level cards 542, 544, 546, 548, and 549 associated with Document card 512, as depicted in FIG. 5D. In the embodiment of FIG. 5D, asset-level cards 542, 544, 546, 548, and 549 are directly linked, respectively, to an individual electronic asset that is accessible to the user (e.g., a document stored on the user's computer). For example, asset-level card 542 is linked to a electronic entitled “mitresearch.doc.” Further, each of the asset-level cards 542, 544, 546, 548, and 549 may be responsive to the actions of the user, including, but not limited to, both the hovering and clicking. In an embodiment, and as described above, hovering over an asset-level card may result in a synopsis of the electronic asset, or other additional information, being displayed to the user.

As described above, respective functionalities of cards 506, 508, 510, 514, 516, and 518 are unaffected by their translation along elongated axis 590. As such, each respective card is still responsive to both hovering and/or clicking by the user. Further, the respective portion of cards 506, 508, 510, 514, 516, and 518 that is visible to the user remains unchanged during the expansion process.

Once the user has viewed the asset-level cards linked to card 512, the user may wish to return bar 502 to its original state. In such an embodiment, the user may re-position the mouse over click region 570 of header card 540a, and click again within region 570 to collapse expansion zone 550 in reverse and return bar 502 to its initial configuration, as depicted in FIG. 5A. In an alternate embodiment, the user positions a mouse pointer over a click region (not shown) of header card 540b and then clicks to collapse expansion zone 550, as described above in FIG. 5B. In an additional embodiment, expansion zone 550 can be collapsed in response to using any actionable input apparent to one skilled in the art, including, but not limited to, one or more keystrokes, a voice command, or the use of touch. Further, expansion zone 550 may be collapsed in response to a period of inactivity of the user, and additionally or alternatively, in response to the user clicking on, hovering over, or otherwise actuating any additional or alternate region within the graphical user interface.

As such, the unselected cards translate along elongated axis 590 to their initial positions, as depicted in FIG. 5A. Further, header cards 540a and 540b in FIG. 5B rejoin to form card 512, which is subsequently responsive to both hovering and clicking by the user or using any actionable input apparent to one skilled in the art, including, but not limited to, one or more keystrokes, a voice command, or the use of touch

In the embodiments described above, a group-level card, such as card 512, may be linked to any number of additional asset-level cards or additional subgroup-level cards, which themselves may be linked to additional asset-level cards. Therefore, an arbitrarily-large variability exists in the number of electronic assets linked to a group-level card, and the variability may be dependent in part or in whole on the preferences of an individual user. Therefore, depending on the number of electronic assets linked to the group-level card, an exposure zone within a bar, such as exposure zone 550 of bar 502, may be insufficient in size to display a portion of all asset-level cards linked to the selected group-level card.

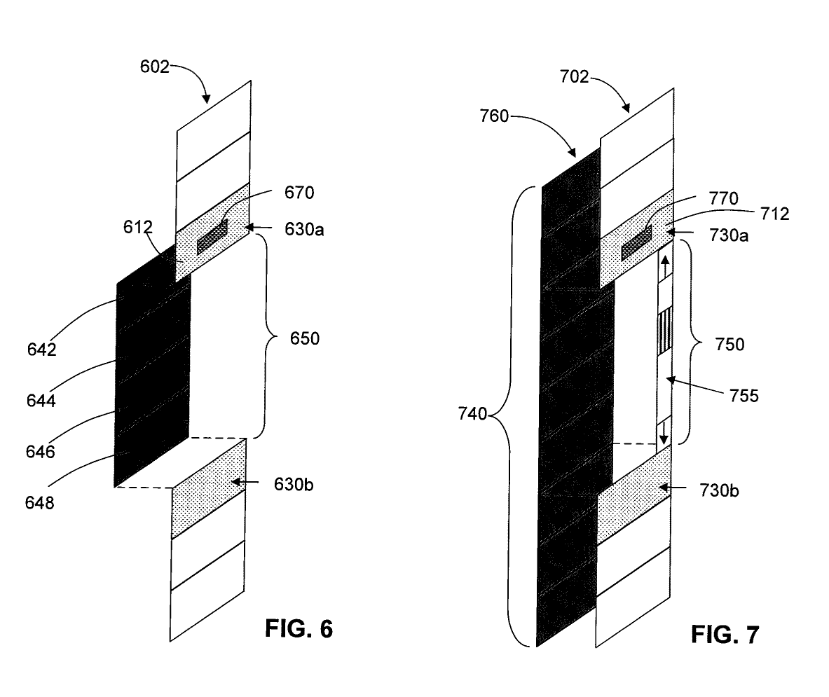

FIG. 6 depicts a plurality of asset-level cards viewed through an expansion zone, according to an embodiment of the present invention. In FIG. 6, a user has clicked within a click region 670 of a group-level card 612, and card 612 has split (or otherwise separated) into header cards 630a and 630b to form an expansion zone 650 between respective header cards 630a and 630b. As described above in reference to FIGS. 5A-5D, the formation of expansion zone 650 between respective header cards 630a and 630b results in a fanning out of asset-level cards 642, 644, 646, and 648 linked to group-level card 612.

In the embodiment of FIG. 6, expansion zone 650 is sufficiently large to display a portion of each of asset-level cards 642, 644, 646, and 648 (or any of an arbitrary number of asset-level card or subgroup-level cards linked to card 612). As described above, those asset-level cards linked to card 612 may gradually fan out within expansion zone 650, may rapidly fan out to instantaneously assume an exposed position within expansion zone 650, or, alternatively, may proceed to an exposed position in any recognizable manner without departing from the spirit or scope of the present invention.

However, in additional embodiments, an expansion zone of a bar, such as expansion zone 550 of bar 502, may be insufficiently large to display all asset-level cards linked to a group-level card, and FIG. 7 depicts a plurality of asset-level cards viewed through an expansion zone, according to an additional embodiment of the present invention. As described with reference to FIG. 6, a user has clicked within a click region 770 of a group-level card 712, thereby splitting (or otherwise separating) card 712 into header cards 730a and 730b and triggering an expansion of a bar 702 and a fanning out of a plurality of asset-level cards, shown generally at 740, that are linked to group-level card 712.

However, unlike the embodiment of FIG. 6, an expansion zone 750 is unable to display a portion of each asset-level card to the user. In FIG. 7, a portion of each of the plurality of asset-level cards 740 are arranged onto a lower bar 760, and expansion zone 750 acts as a window through which the user may view a subset of the plurality of asset-level cards. In one embodiment, a scroll bar 755 is provided along a elongated edge of expansion zone 750, and the user may adjust a position of lower bar 760 by clicking on an appropriate part of the scroll bar, thereby selecting a subset of portions of asset-level cards to view through expansion zone 750. In an additional embodiment (not shown) a scroll bar may be positioned along an edge of a header card, such as card 540a of FIG. 5D, proximate to expansion zone 750, and the user may position lower bar 760 by clicking on an appropriate portion of the scroll bar. As described above in reference to FIG. 4, the scroll bar may be replaced with a flashing dot, or any additional or alternate flashing or non-flashing image, to actuate scrolling. In an additional embodiment, scrolling may be accomplished by use of the same type of “invisible scroll zones” described above with reference to FIG. 4C.

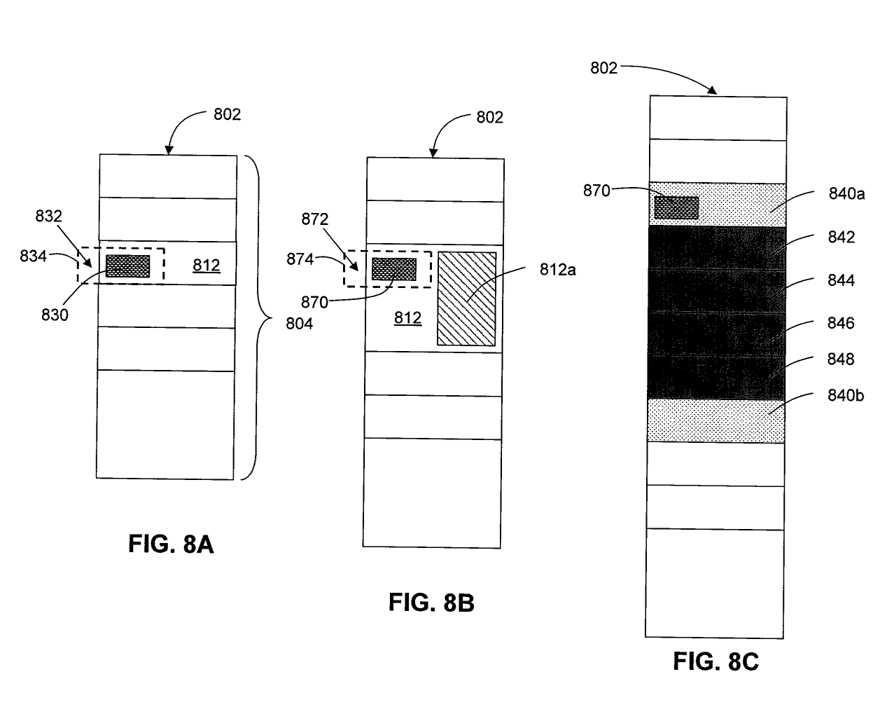

FIGS. 8A, 8B, and 8C depict an exemplary process through which a user obtains information on and views electronic assets linked to a group-level card, according to an embodiment of the present invention. In FIG. 8A, a bar 802 of a graphical user interface, such as that depicted in FIG. 1A, includes a plurality of group-level cards, shown generally at 804. In an embodiment, a user may position a mouse pointer over a hover region 830 of an individual card 812, and in response to the hovering of the pointer over hover region 830, card 812 expands to display additional information 812a regarding the one or more additional electronic assets associated with card 812, as depicted in FIG. 8B.

In the embodiment of FIG. 8A, hover region 830 corresponds to only a part of the exposed portion of card 812. However, in additional embodiments, a hover region associated with card 812 may incorporate any part of the exposed portion of card 812, including, but not limited to, the entire exposed portion of card 812, without departing from the spirit or scope of the present invention. In additional embodiments, a part of card 812 may be reserved for other activities, including, but not limited to, sharing, and therefore may be unresponsive to hovering.

In an additional embodiment, hover region 830 may be surrounded by a buffer zone 832, and a dashed line 834 indicates the boundaries of buffer zone 832 that surrounds hover zone 830. In such an embodiment, buffer zone 832 incorporates an additional area of space, surrounding hover region 830, that is responsive to hovering by a mouse pointer. As such, buffer zone 832 accounts for a user who intends to hover the mouse pointer over hover zone 830, but whose positioning over the hover region may be inaccurate. Further, any embodiment of a hover zone associated with card 812 or any additional card, such as that encompassing the entire exposed portion of card 812, may be likewise surrounded by a buffer zone, such as buffer zone 832.

In an additional embodiment, the user may then click on a portion of card 812 to view those asset-level cards associated with card 812, as depicted in FIGS. 8B and 8C and discussed in detail above with reference to FIGS. 4A-4C and 5A-5D. In FIG. 8B, the user may position the pointer within a click region 870 of the expanded card 812 and subsequently click within click region 870 to view the asset-level cards associated with card 812.

In the embodiment of FIG. 8B, click region 870 incorporates only a portion of expanded card 812. However, in additional embodiments, click region 870 may incorporate any portion of expanded card 812, including, but not limited to, the entire exposed portion of expanded card 812, without departing from the spirit or scope of the present invention.

In an embodiment, click region 870 may be surrounded by a buffer zone 872, the boundaries of which are indicated by a dotted line 874. In such an embodiment, buffer zone 872 incorporates an additional area of space surrounding click region 870 that is responsive to hovering by a mouse pointer. As such, buffer zone 872 accounts for a user who intends to hover the mouse pointer over hover zone 872, but whose positioning of the mouse pointer over click region 872 is inaccurate. Further, in an embodiment of a click zone associated with expanded card 812, such as that encompassing the entire exposed portion of expanded card 812, may likewise be surrounded by a buffer zone, such as buffer zone 872. One skilled in the art would recognize that buffer zone 872 may be of any of a number suitable sizes and shapes without departing from the spirit or scope of the invention.

In FIG. 8C, and as described above, the user has clicked within click zone 870 (or within surrounding buffer zone 872), and card 812 has split into header cards 840a and 840b that, respectively, bracket an exposed plurality of asset-level cards 842, 844, 846 and 848 linked card 812. Each of the asset-level cards may be linked directly to a corresponding electronic asset, and the user may hover or click within a region of an asset-level card to obtain information on or view the electronic asset, respectively, as described below.

In the embodiments described above, a user clicks within a click region of a group-level card (or alternatively, a subgroup-level card) to view one or more asset-level cards (or subgroup-level cards) linked to the group-level card. In an embodiment, the linked cards may be viewed by the user in random order. However, in an additional embodiment, the user may view an ordered list of linked cards that have been filtered such that more recently-accessed cards are displayed to the user ahead of less-recently accessed cards. Further, the more recently-accessed cards may be prioritized within the list based on a graphical indicator, such as a color of the card, a font of the card, or a graphical element associated with the card. In additional embodiments, the ordered list of cards may be filtered according to title, a size of a linked electronic asset, or through any additional parameter, combination of parameters, or technique that would be apparent to one skilled in the art.

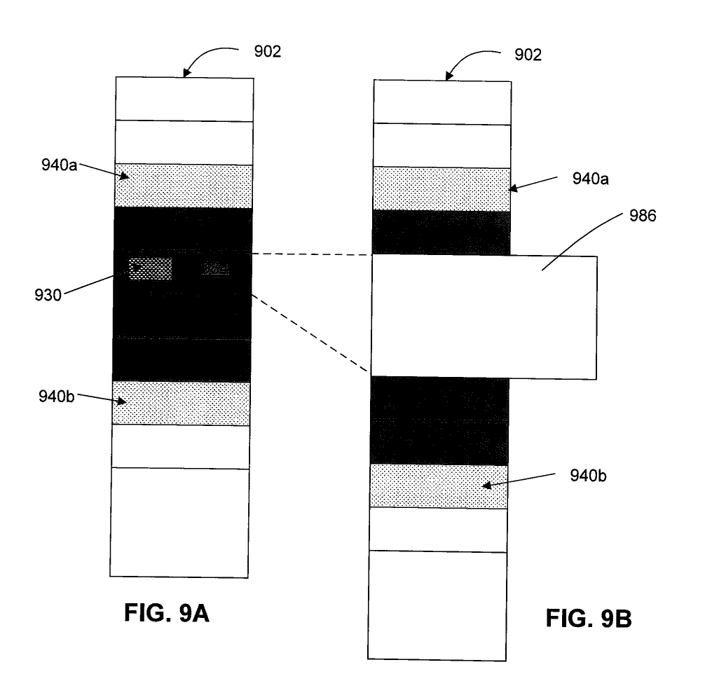

FIGS. 9A and 9B describe a process by which a user obtains additional information on an electronic asset associated with an asset level card, according to an embodiment of the present invention. In FIG. 9A, the user has accessed a plurality of asset-level cards (and potentially subgroup-level cards) linked to a group-level card within bar 902. In an embodiment, the user may obtain information regarding an electronic asset (e.g., a document, an email, bookmark, or a URL) associated with an asset-level card 984 by positioning a mouse pointer over a hover region 930 associated with asset-level card 984.

As described above, hover region 930 incorporate only a small portion of asset-level card 984. However, in additional embodiments, hover region 930 may encompass incorporate any portion of asset-level card 984, including, but not limited to, the entire exposed portion of asset-level card 984, without departing from the spirit or scope of the present invention. Further, hover region 930 may also include a buffer region (not shown) that may also be responsive to the hovering of the mouse pointer.

Once the user hovers the mouse pointer over hover region 930, asset-level card 984 splits (or otherwise separates) into header cards 940a and 940 that, respectively, bracket a two-dimensional expanded asset-level card 986 that displays a summary of the electronic asset associated with asset-level card 984, as depicted in FIG. 9B. In an embodiment, expanded card 986 displays a text summary of the electronic asset or alternatively, expanded card 986 may display a thumbnail image, sound, voice, or movie clip of the electronic asset. In an additional embodiment, expanded card 986 may display a combination of a text and thumbnail image, or any additional summary apparent to one skilled in the art and appropriate to the electronic asset, without departing from the spirit or scope of the present invention.

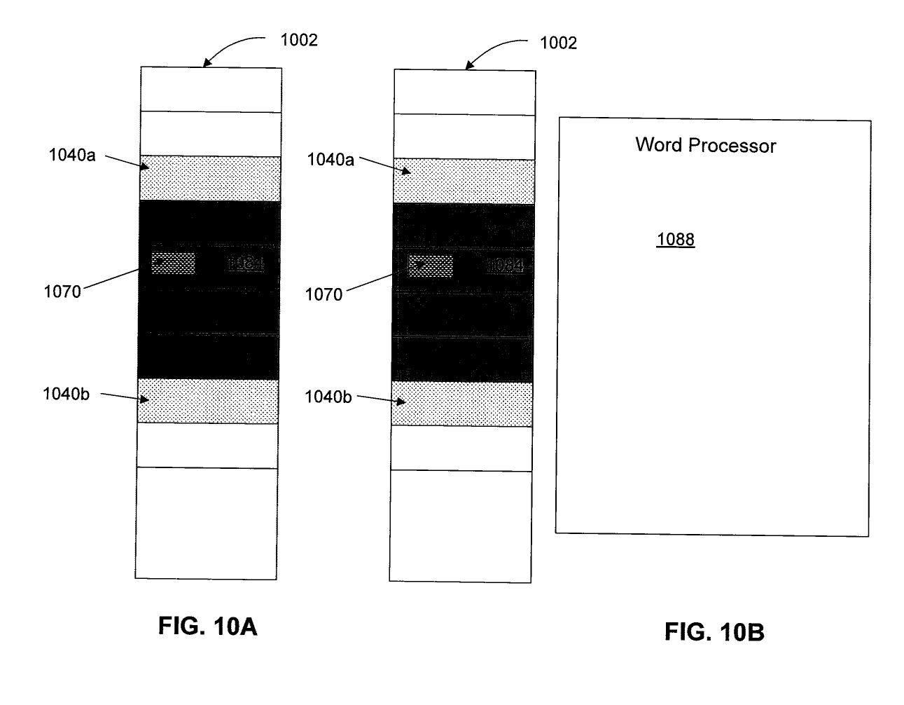

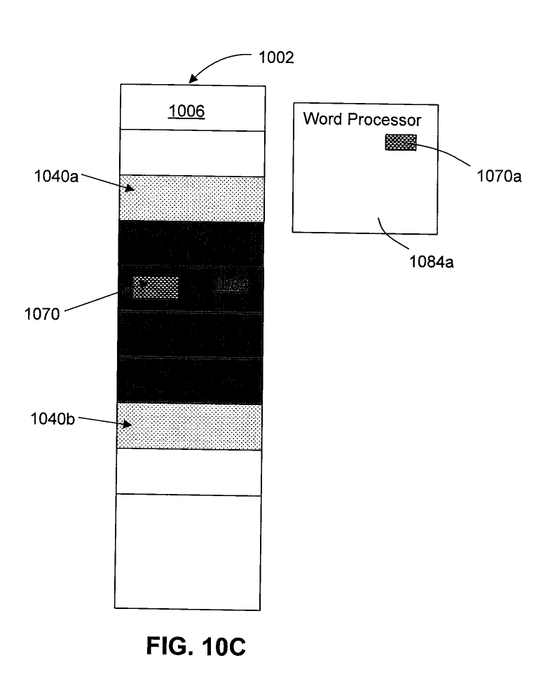

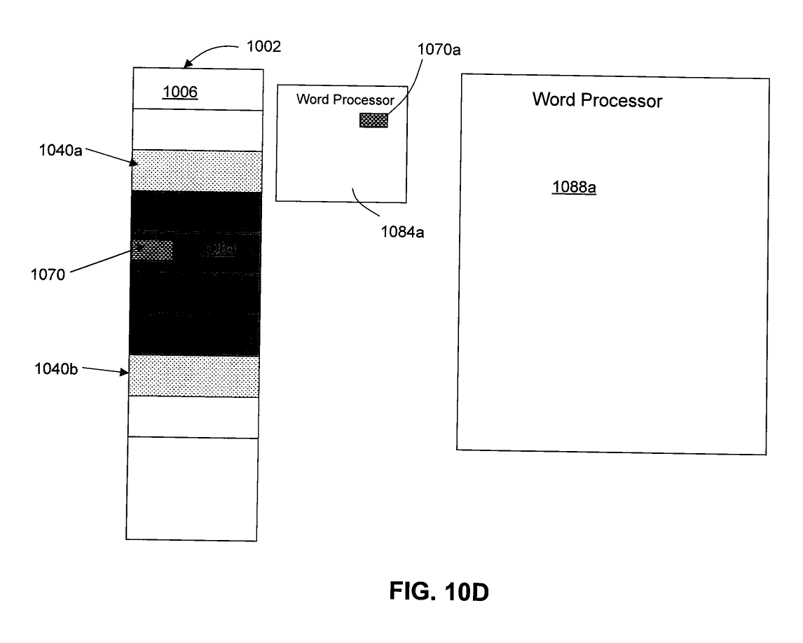

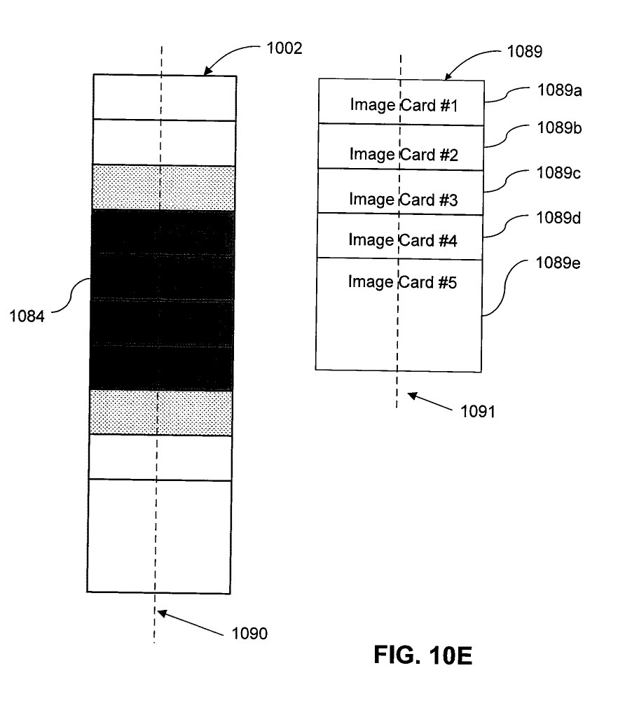

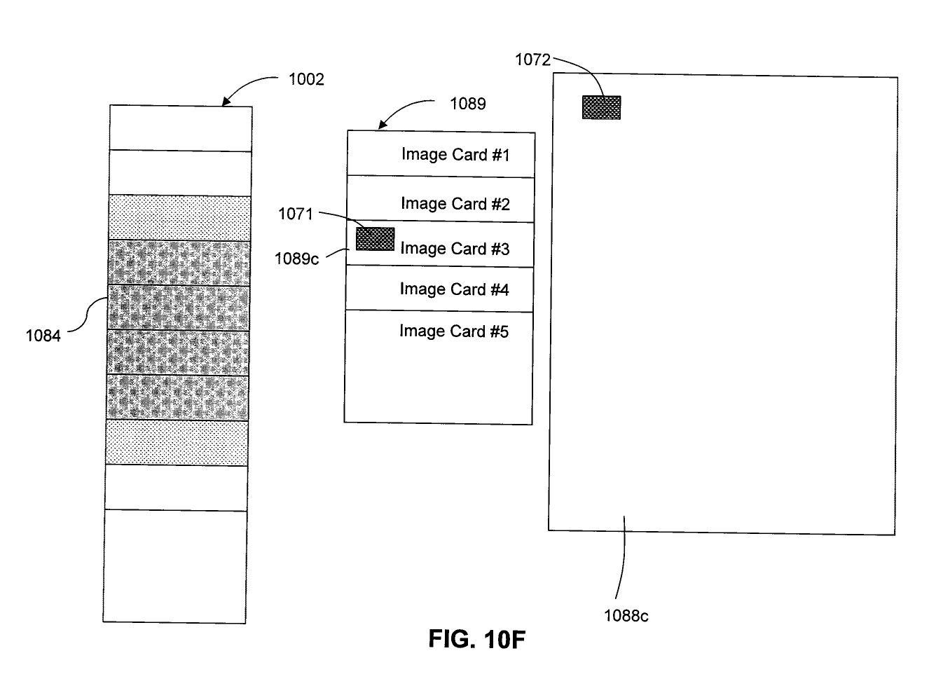

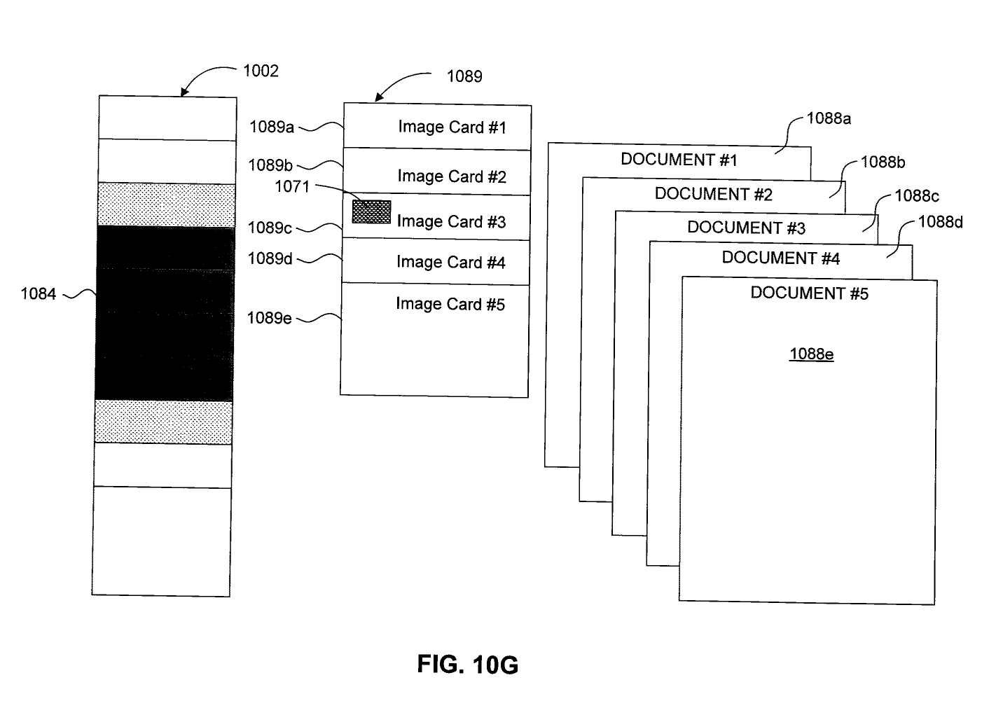

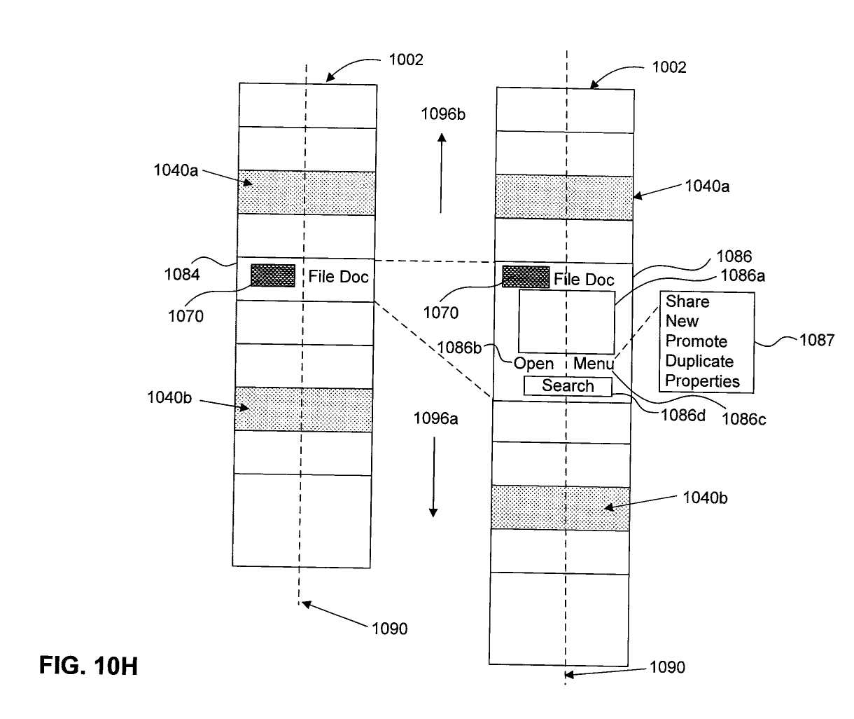

FIGS. 10A-10D depict exemplary processes by which a user views an electronic asset associated with an asset level card, according to embodiments of the present invention. In FIG. 10A, and as described above, the user has accessed a plurality of asset-level cards, and potentially, group-level cards, associated with a group-level card of bar 1002. In an embodiment, the user may view an electronic asset (e.g., document, email, or URL) associated with an asset-level card 1084 by positioning a mouse pointer over a click region 1070 associated with asset-level card 1084 or by voice or other trigger activity.

As described above, click region 1070 incorporate only a portion of asset-level card 1084. However, in additional embodiments, click region 1070 may encompass incorporate any portion of asset-level card 1084, including, but not limited to, the entire exposed portion of asset-level card 1084, without departing from the spirit or scope of the present invention. Further, click region 1070 may also include a buffer region (not shown) that may also be responsive to the hovering of the mouse pointer.

Once the user clicks within click region 1070 (or the buffer region), asset level card 1084 splits (or otherwise separates) into header cards 1040a and 1040b, and the electronic asset is opened in a large window 1088 positioned adjacent to bar 1002 using its native application, as depicted in FIG. 10B. For example, for an asset-level card associated with a word processing document, clicking on click region 1070 would open the word processing document using the native word processing application in large window 1088.

As depicted in FIG. 10C, an image 1084a of the electronic asset can be generated in response to the user clicking within the click region 1070 of asset-level card 1084. In FIG. 10C, image 1084a is positioned proximate to card 1006 of bar 1002, although in additional embodiments, image 1084a may be positioned at any location relative to bar 1002 and would be apparent to one skilled in the art and without departing from the spirit or scope of the present invention.

Image 1084a can include a synopsis of the corresponding electronic asset. For example, an image of a word processing document may include an image of a portion of the word processing document and additionally or alternatively, a summary of the document (e.g., a title of the document, a size of the document, etc.). Further, for example, an image of stored photograph or a stored video may include, respectively, a portion of the stored photograph or a portion of an image from the stored video. However, the present invention is not limited to such embodiments, and one skilled in the art would recognize that any number of additional or alternate images could represent an electronic asset without departing from the spirit or scope of the present invention. For example, a synopsis of image 1084a can be a multimedia summary or description of the underlying contents of the electronic asset associated with image 1084a.

In an embodiment, the user may view the electronic asset (e.g., document, email, or URL) associated with image 1084a, and hence, associated with asset-level card 1084 by clicking within a click region 1070a associated with image 1084a, or alternatively, through one or more keystrokes, voice activation, use of touch, or any other appropriate user action. Further, and as described above, click region 1070a may be surrounded by a buffer region (not shown) that is similarly responsive to user action.

Once the user clicks within click region 1070a (or its buffer region), the electronic asset is opened in a large window 1088a adjacent to image 1084a using its native application, as depicted in FIG. 10D. For example, for an image associated with a word processing document, clicking on click region 1070a would open the word processing document using the native word processing application in large window 1088a.

The embodiments of FIGS. 10C and 10D include a single image of an electronic asset associated with an asset-level card, such as image 1084a of the electronic asset associated with card 1084. However, the present invention is not limited to single images associated with single asset-level cards, and in an additional embodiment, a user may click within a click region of multiple asset-level cards to generate multiple images of electronic assets associated, respectively, with a corresponding asset-level card acted upon by the user.

FIGS. 10E and 10F depict exemplary processes by which a user manages multiple electronics assets, according to an embodiment of the present invention. In FIG. 10E, a user has clicked within a click region of multiple asset-level cards, and an image of an electronic asset corresponding to each clicked-upon asset-level card has been generated and arranged in a “window deck” or image bar 1089.

In the embodiment of FIG. 10E, the image bar 1089 includes image cards 1089a through 1089e, which have been generated, respectively, in response to the user clicking within a click region of a corresponding asset-level card. Similar to the arrangement of cards 106 through 118 of FIG. 1, image cards 1089a through 1089e are arranged along an axis 1091 that is parallel to an axis 1090 of bar 1002. Further, image cards 1089a through 1089e are arranged along axis 1091 such that a only a portion of image cards 1089a through 1089d are exposed, while image card 1089e is completely visible to the user. In an embodiment, images cards 1089a through 1089e may be arranged, or alternatively, re-arranged, automatically, or in response to a user input (e.g., dragging, dropping, and/or any additional user action) into any configuration apparent to one skilled in the art.

Each image card within a corresponding image bar includes a region responsive to an action of a user, including, but not limited to, clicking, hovering, one or more keystrokes, a mouse click, a voice command, or a use of touch. For example, image card 1089c of FIG. 10F, which includes an image of an electronic asset associated with a corresponding asset-level card, includes a click region 1071 responsive to clicking. As described above, click region 1071 may incorporate any exposed portion of image card 1089c, and a buffer region of any size or shape (not shown) may surround click region 1071 and may be responsive to the user action, as described above.

As depicted in FIG. 10F, the user clicks within click region 1071 (or alternatively, the buffer region) of image card 1089c, whereupon the electronic asset associated with the image card opens into a large widow 1088c adjacent to image bar 1089. For example, if image card 1089c were an image of a word processing document, clicking within click region 1071 would open the document in its native application within large window 1088c.

Further, large window 1088c may include a region 1072 that is responsive to user actions, including, but not limited to a mouse click, a voice command, or a use of touch, and that allows the user to close or minimize large window 1088c. For example, the user may position a mouse pointer within click region 1072 and subsequently click within that region to close large window 1088c. In an additional embodiment, large window 1088c may close or may be minimized automatically in response to a period of idleness. For example, large window 1088c may close when the user has not clicked within larger window 1088c, or acted in any fashion appropriate to the native application of large window 1088c, within a specified time period (which may be set automatically or modified by a user). Alternatively, or additionally, large window 1088c may be closed or minimized when a user clicks upon a click region of an additional image card, such as those depicted on image bar 1089 of FIG. 10F.

In an embodiment, image bar 1089 remains visible to a user while the user views electronic assets (e.g., images corresponding to respective images within image bar 1089) within window 1088c. As such, the user is able to maneuver through and manipulate open windows by selectively clicking on respective images within image bar 1089.

Further, in an embodiment, each image card within image bar 1089 (e.g., image cards 1089a through 1089e) may be associated with a respective electronic asset open within a corresponding large window, as depicted in FIG. 10G. In FIG. 10G, a user has clicked on, hovered over, or otherwise activated a corresponding region within each of image cards 1089a through 1089e to open a linked electronic asset within a respective one of large windows 1088a through 1088e, as described above in reference to FIG. 10F.

Additionally or alternatively, the user may clink on, hover over, or otherwise actuate a region of one or more cards within bar 1002 (e.g., region 1070 of card 1084) to directly open a corresponding electronic asset in a large window (e.g., large windows 1088a through 1088e). Upon opening the electronic asset in the corresponding large window, an image of that electronic asset is positioned within image bar 1089. For example, the user may clink on, hover over, or otherwise actuate region 1070 of card 1804, thereby opening the linked electronic asset in large window 1088c and placing image card 1089c of the linked electronic asset in image bar 1089.

In FIG. 10G, only a portion of large windows 1088a through 1088d, which corresponding respectively to image cards 1089a through 1089d, is visible to the user. However, as image card 1089e is completely visible to the user, a document corresponding to the image within image card 1089e is completely visible to the user within large window 1088e.

In the embodiment of FIG. 10G, the user can view a document displayed within one of partially-obscured windows 1088a through 1088d in its entirety by clicking on, hovering over, or otherwise activating a region within the image card that corresponds to the large window. For example, the user may click on, hover over, or otherwise activate region 1071 of card 1089c to render large window 1088c completely visible to the user, thereby partially-obscuring large window 1088e.

In the embodiments of FIGS. 10F and 10G, image bar 1089 is positioned between the large windows and bar 1002. However, the present invention is not limited to such configurations, and in additional embodiments, image bar 1089 can be positioned at any location proximate to both bar 1002 and large windows 1088a through 1088e. Further, the embodiments of FIGS. 10F and 10G are not limited to images bars that include image cards arranged in any particular order. In an additional embodiment, image cards 1089a through 1089e of image bar 1089 can be arranged randomly, according to any ranking algorithm, or according to any user-specified pattern without departing from the sprit or scope of the present invention.

As depicted in FIG. 10C, an image 1084a of the electronic asset can be generated in response to the user clicking within the click region 1070 of asset-level card 1084, and the generated image can be positioned proximate to card 1084. However, the generated image is not limited to such configurations, and in additional embodiments, the user may hover over region 1070 of asset level card 1084 to expand asset-level card 1084 in a single dimension along an elongated axis 1090 to form an expanded asset-level card 1086, as depicted in FIG. 10H. In such an embodiment, the remaining cards within bar 1002 translate along axis 1090 to accommodate expanded asset-level card 1086, as described above in reference to FIGS. 4A-4C.

In FIG. 10H, expanded asset-level card 1086 includes a synopsis 1086A of the electronic asset associated with expanded asset-level card 1086. In various embodiments, synopsis 1086A can include an image of one or more portions of the electronic asset, a text summary of one or more portions of the electronic asset, or any additional textual or multimedia synopsis that would be apparent to one skilled in the art.

In contrast to the embodiments described above, a user may open the electronic asset associated with expanded asset-level card 1086 in a large window, such as window 1088c of FIG. 10F, by clicking, hovering over, or otherwise activating an “Open” region 1086B of expanded asset-level card 1086. In addition, the user may search for one or more words or phrases within the electronic asset associated with expanded asset-level card 1086 by entering any combination of a free-form or Boolean search query into text box 1086C.

In additional embodiments, expanded asset-level card 1086 may include alternate or additional regions that provide functionality specific to the electronic asset associated with the card. For example, functionality provided by Open region 1086B of expanded asset-level card 1086 can be useful for a variety of electronic assets, including, but not limited to, text documents, spreadsheets, presentations, email messages, calendar appointments, and multimedia files. However, for an electronic asset in the form of an email message or instant message, expanded asset-level card 1086 may incorporate a “Reply” region that, upon activation, allows the user to reply to the email message using a native email client or other email program associated with the graphical user interface. Similarly, for an electronic asset in the form of a calendar appointment, expanded asset-level card 1086 may include any combination of an “Accept” region and a “Decline” region. Further, for example, expanded asset-level card 1086 could include a “Preview” region that, upon activation, would allow the user to preview a portion of an audio or video file linked to expanded asset-level card 1086. In additional embodiments, expanded asset-level card 1086 may include any number and type of function regions specified to an electronic asset and apparent to one skilled in the art without departing from the spirit or scope of the present invention.

Further, in the embodiment of FIG. 10H, the user may manage the electronic asset associated with expanded asset-level card 1086 by clicking on, hovering over, or otherwise activating a “Menu” region 1086B of expanded asset-level card 1086. In such an embodiment, an Menu bar 1087 may be generated and may be positioned proximate to expanded asset-level card 1086. However, in additional embodiments, Menu bar 1087 may partially-obscure any portion of expanded asset-level card 1086, or any additional portion of bar 1002, without departing from the spirit or scope of the present invention

In such an embodiment, the user may activate any individual region within Menu bar 1087, including, but not limited to a “Share” region, a “New” region, a “Promote” region, a “Duplicate” region, and a “Properties” region, by clicking within the region, hovering over the region, or otherwise activation the region, e.g., through a use of touch, voice, or other action. For example, the user may activate the Share region to electronically share the electronic asset associated with expanded asset-level card 1086 with an individual, regardless of whether or not the individual utilizes the graphical user interface of the present invention.

Further, by activating the New region, the user may create and open a new document using the underlying application of the electronic asset associated with expanded asset-level card 1086. For example, if the electronic asset were a word processing document, then the user would open a new word processing document using the native word processing application upon activating the New region.

The user may also duplicate asset-level card 1084, and hence the linked electronic asset, by activating the Duplicate region within Menu bar 1087 of expanded asset-level card 1086. Additionally, the user may activate the Properties region to obtain information on the electronic asset linked to expanded asset-level card 1086, including, but not limited to a size of the electronic asset and a date on which the file was last modified.

As described above, group-level card 1002 may be linked to any number of individual electronic assets. As such, an arbitrary number of asset-level cards may be displayed to a user and ranked according to any number of ranking algorithms, e.g., a date on which the electronic asset was last modified. However, despite this ranking, the user may regularly use an electronic asset whose asset-level card is positioned towards a bottom of the card deck, and as such, would require the user to scroll through numerous asset-level cards to locate the desired electronic asset.

In such an embodiment, the user can activate the Promote region of Menu bar 1087 to promote expanded asset-level card 1086, and hence, asset-level card 1084, to the top level of the card deck. The promotion may be accomplished either by removing the card from its former place in the deck and moving it to the top level, or by creating a shortcut to the original card at the top level, which will be the same in appearance as the original card. Once a card is promoted, the “Promote” region of Menu bar 1087 can change to a “Demote” function, which may be invoked in the same manner as “Promote” to return a card to its original place in the card deck structure, and/or delete any top-level shortcuts that have been made.

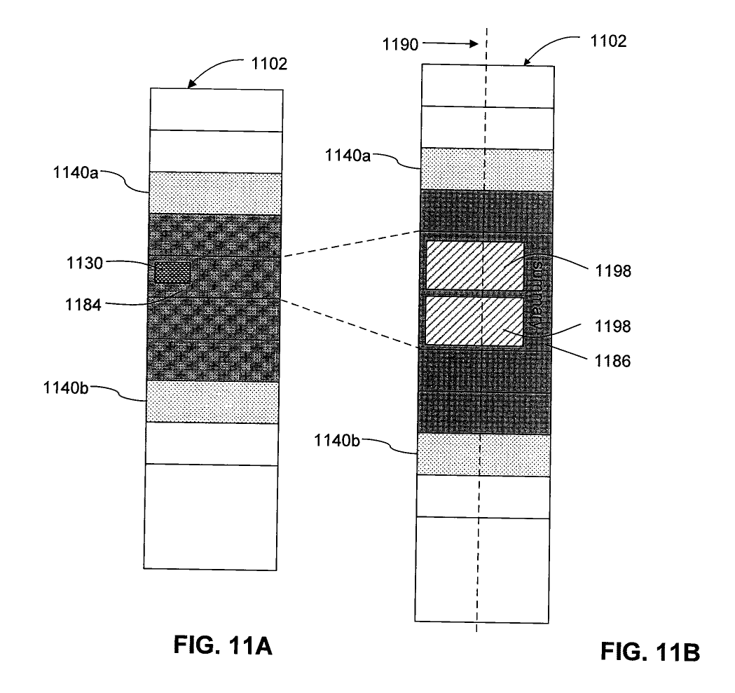

The embodiments of FIGS. 9A-9B and 10A-10H have been described in terms of a graphical user interface, such as graphical user interface 100 of FIG. 1, displayed on a large-screen display, including, but not limited to, those displays characteristic of computer monitors, laptop computers, and any variety of televisions. However, the present invention is not limited to such embodiments, and FIGS. 11A and 11B depict a process by which a user obtains information on an electronic asset linked to an asset-level card using a small screen display, according to an embodiment of the present invention. In the embodiments of FIGS. 11A and 11B, the small-screen display may include, but is not limited to, a display of a cellular telephone, personal digital assistance (PDA), smart phone, remote control, media player, a navigational device, such as an advanced computer mouse, or a display on any additional device apparent to one skilled in the art.

In FIG. 11A, the user has accessed a plurality of asset-level cards (and potentially subgroup-level cards) associated with a group-level card of a bar 1102. Further, the user may obtain information regarding an electronic asset (e.g., document, email, or URL) associated with an asset-level card 1184 by positioning a mouse pointer over a hover region 1130 associated with asset-level card 1184.

As described above, hover region 1130 incorporate only a small portion of asset-level card 1184. However, in additional embodiments, hover region 1130 may incorporate any portion of asset-level card 1184, including, but not limited to, the entire exposed portion of asset-level card 1184, without departing from the spirit or scope of the present invention. Further, hover region 1130 may also include a buffer region (not shown) that may also be responsive to the hovering of the mouse pointer.

Unlike the embodiments of FIGS. 9A-9B, once the user hovers the mouse pointer over hover region 1130, asset-level card 1184 expands in a single dimension along an elongated axis 1190 to form an expanded asset-level card 1186, which is bracketed by respective header cards 1140a and 1140b and which displays a summary of the electronic asset associated with asset-level card 1184, as depicted in FIG. 11B. In an embodiment, expanded card 1186 displays a text summary of the electronic asset in columns 1198 oriented perpendicularly to elongated axis 1190. Alternatively, expanded card 1186 may include one or more thumbnail images of the electronic asset oriented in columns 1198 perpendicular to elongated axis 1190. In an additional embodiment, expanded card 1186 may display a combination of a text and thumbnail image, or any additional summary of any additional shape and along any axis apparent to one skilled in the art and appropriate to the electronic asset, without departing from the spirit or scope of the present invention.

By orienting summary information in columns 1198 perpendicular to elongated axis 1190 of bar 1102, the graphical user interface leverages the inherent portability of small-screen devices to provide a maximum amount of information within a minimum amount of space. Although the graphical user interfaces of FIGS. 11A and 11B leverage the inherent portability of small-screen devices, such graphical user interfaces may be displayed within any large-screen display or small-screen display apparent to one skilled in the art, with alone or in combinations with any of the embodiments described above.

In the embodiments described above, specific reference has been made to group-level cards, such as card 512 of FIG. 5A, that are linked directly to asset-level cards, such card 542 of FIG. 5D. In additional embodiments, a graphical user interface, such as graphical user interface 100 of FIG. 1, may also incorporate a group-level card that is linked to one or more subgroup-level cards, which are linked, respectively, to one or more asset-level cards. For example, card 512 of FIG. 5A may be linked to subgroup-level cards that divide the electronic assets associated with card 512 into categories, such as a subgroup-level card for word-processing documents and a subgroup-level card for spreadsheet documents.

Further, in additional embodiments, a group-level card may be linked directly to both asset-level card and to subgroup-level cards, which themselves are linked to additional asset-level cards. In such embodiments, a hierarchical tree of groupings would exist, with the lowest level of cards corresponding to asset-level cards, the highest level of cards corresponding to group-level cards, and an intermediate level of cards corresponding to subgroup-level cards. Therefore, in an additional embodiment, those processes described herein that allow a user to manipulate, manage, and view asset-level cards linked to a group-level card may additionally be applied to asset-level cards linked to a subgroup-level card without departing from the spirit or scope of the present invention.

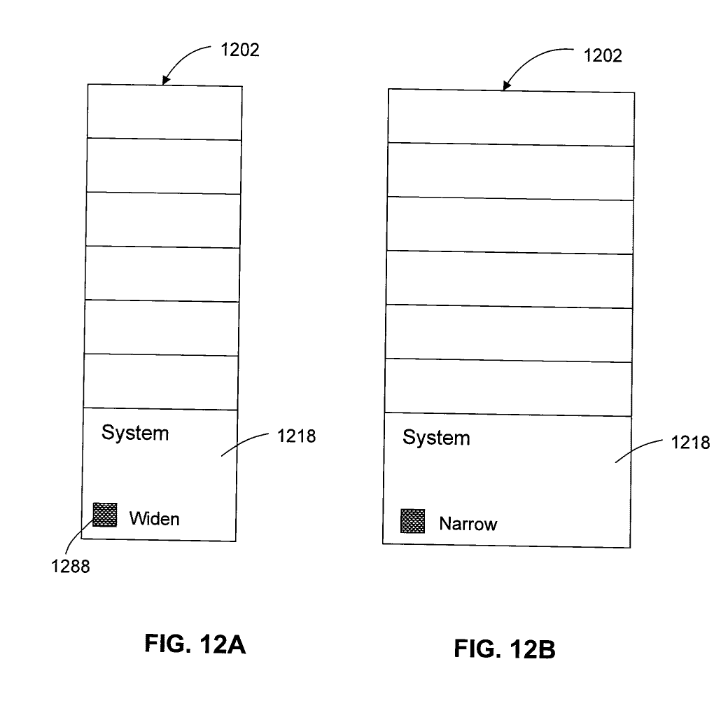

FIGS. 12A and 12B illustrate features of a system-level card within a bar of an exemplary graphical user interface, in accordance with an embodiment of the present invention. In FIGS. 12A and 12B, a graphical user interface includes a bar 1202, which features a plurality of group-level cards, shown generally at 1204, and a system-level card 1218.

In one embodiment, system-level card 1218 manages a functionality of graphical user interface 100, and alternatively or additionally, a functionality of a computer system on which graphical user interface 100 operates. For example, system-level card 1218 may allow a user to search for any of a number of electronic assets stored within the computer system and linked to one or more group-level or asset-level cards. Further, system-level card 1218 may provide a user an opportunity to create an additional card within the plurality or to share one or more cards within the plurality with another user.

Further, system level card 1218 may modify an appearance of the graphical user interface. In particular, system level card 1218 may adjust a font of the typeface used to identify group-level cards 1204 within bar 102, and additionally, modify a font of the typeface of a set of streamers, such as streamers 120 of FIG. 1. For example, system-level card 1218 may allow a user to change an existing ten-point Arial font to a fourteen-point Times New Roman font in an effort to increase readability or change the look and design.

Further, as depicted in FIG. 12, system-level card 1218 may modify a width of bar 1202, and hence, a width of group-level cards 1204 and system-level card 1218. In FIG. 12A, a user may position a mouse pointer over a “Widen” icon 1288 and click on that icon, thereby increasing the width of bar 1202, as depicted in FIG. 12B. The present invention is not limited to the interaction between system-level cards and group-level cards described herein. In additional embodiments, a system-level card, and one or more corresponding group-level cards, may operate, function, or be displayed in any manner apparent to one skilled in the art without departing from the spirit or scope of the present invention.

As described above, the graphical user interface of the present invention can be viewed on a large screen display, including, but not limited to, displays characteristic of computer monitors, laptop computers, and televisions, such as those with “large screen” displays, high-definition (HD) displays, or combinations thereof. Further, in additional embodiments, the graphical user interface of the present invention can be viewed on a “small-screen” screen or display characteristic of a remote control, a navigational device for a computer, such as a mouse, or any other device that would be apparent to one skilled in the art.

However, in additional embodiments, the graphical user interface of the present invention can be implemented on devices that have neither a native screen nor a native display. In such embodiments, the graphical user interface can be executed by an interface device that couples one or more devices that store electronic assets to one or more devices that display devices that display such assets. For example, an interface device may be connected to a “large-screen” display, such as a television or computer monitor, and may allow the user to view one or more digital images and videos (or other electronic assets) on the display using the graphical user interface. These digital images can be stored locally on the interface device using a removable hard disk or other device appropriate device. Additionally or alternatively, such electronic assets can be stored remotely on a native device, such as a digital camera or camcorder, that is connected to the interface device, or on a portable memory device, such as a flash drive.

In the foregoing embodiments, examples, and figures, reference is made to graphical user interfaces having a specified number of cards and having cards of a specified name. The present invention is not limited to graphical user interfaces having a specific number of cards. In additional embodiments, the graphical user interfaces of the present invention may incorporate any number of group-level cards apparent to one skilled in the art. Further, each of these group-level cards may be linked to any number of asset-level cards and any number subgroup-level cards, which are linked to additional asset-level and subgroup-level cards, thereby forming a hierarchy of arbitrary depth.

In addition, one skilled in the art would recognize that any name associated with one or more of a group-level cards (e.g., the Communicator and Organizer cards of FIG. 1A), one or more subgroup-level cards, and one or more asset-level cards is provided for exemplary purposes only. In additional embodiments, group-level, asset-level, and subgroup-level cards could have any additional or alternative name without departing from the spirit or scope of the present invention.

In the embodiments and figures described herein, reference is made to a user obtaining a particular result by clicking (either singly or doubly) within a click region of a card or window, by hovering a mouse pointer within a hover region of a card or window, and by dragging and dropping one or more cards onto another card or onto a streamer. The present invention, and the embodiments described herein, is not limited to user actions initiated by the positioning of a mouse pointer within a hover or click region or any subsequent clicking within the click region, or to actions initiated by dragging and dropping one or more cards onto another card or onto a streamer. In additional embodiments, a mouse click, a hovering of a mouse pointer, and one or more of the dragging and dropping of a card may be replaced by any suitable user action apparent to one skilled in the art, including, but not limited to, one or more keystrokes, a voice command, a digitized voice command, and the use of touch. Further, in an additional embodiments, any such click region, hover region, or other region can be surrounded by a buffer zone or region of any size apparent to one skilled in the art. For example, a click region can be surrounded by a buffer zone or region that is responsive to clicking.

### EXAMPLE 1

### Tracking User Activity Using a Graphical User Interface

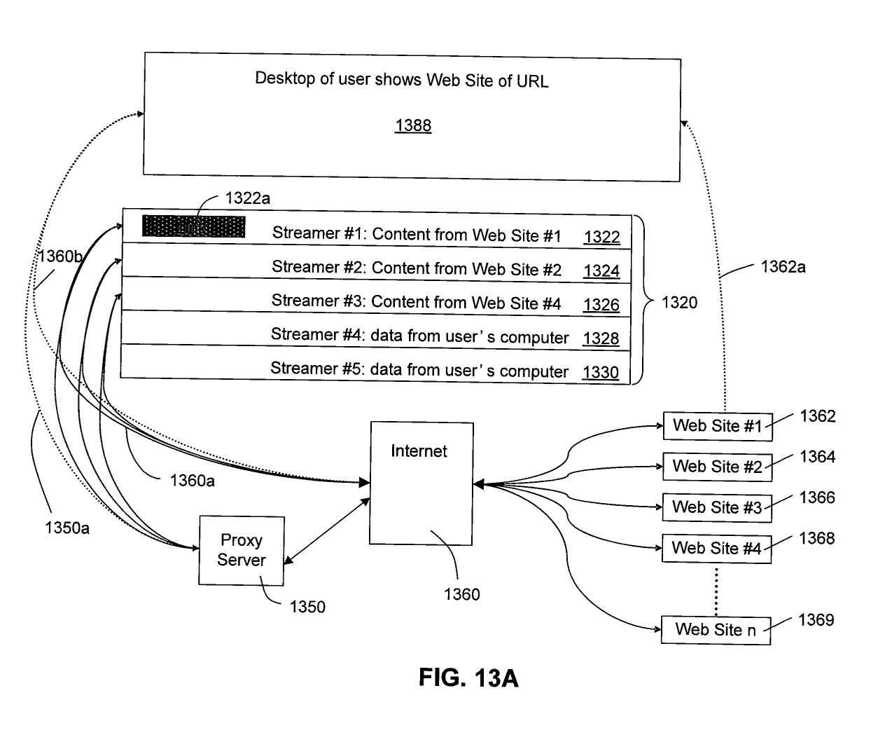

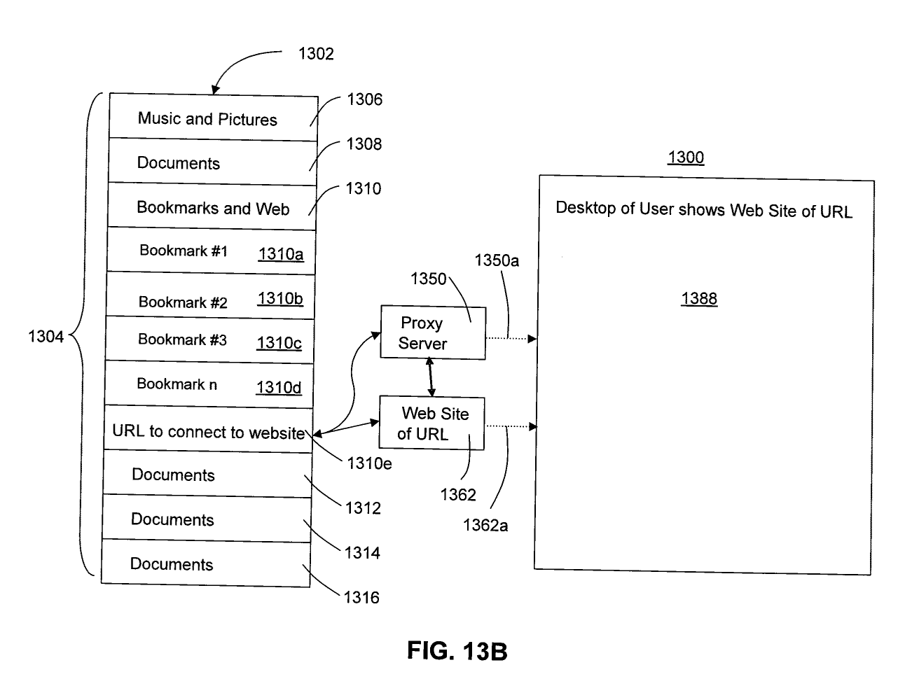

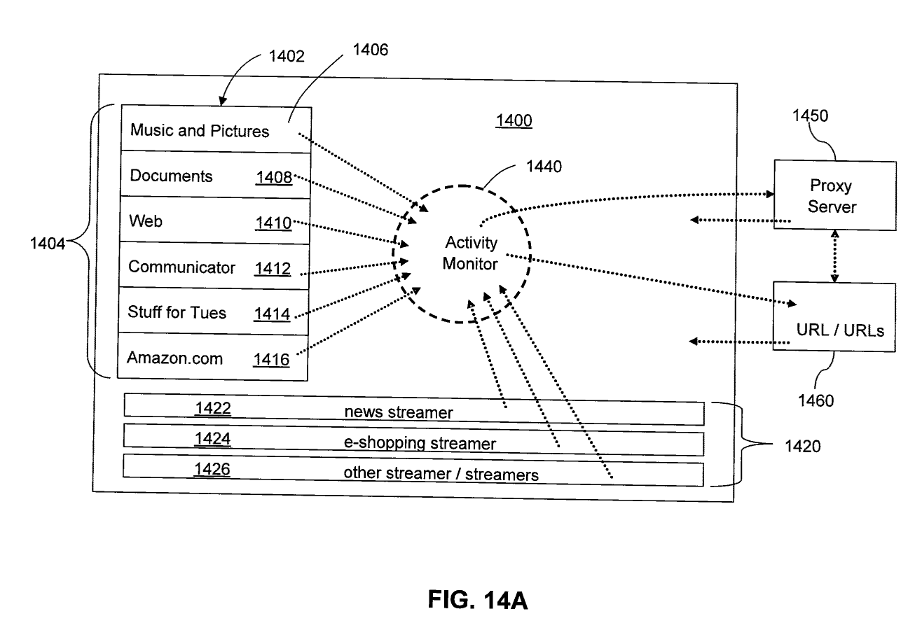

FIGS. 13A and 13B schematically depict an exemplary proxy server that monitors internet activity of a user of a graphical user interface 1300, according to an embodiment of the present invention. In FIG. 13A, graphical user interface 1300 includes a set of streamers, shown generally at 1320. In the embodiment of FIG. 13A, streamers 1320 include a first streamer 1322, a second streamer 1324, a third streamer 1326, a fourth streamer 1328, and a fifth streamer 1330, which respectively stream different types of data to a user.

For example, first streamer 1322, second streamer 1324, and third streamer 1326 may be configured, respectively, to display content from a first website 1362 of internet 1360, a second website 1364 of internet 1360, and a fourth website 1368 of internet 1360. The content streamed by first streamer 1322, second streamer 1324, and third streamer 1326 may, respectively, include any combination of links to world-wide web content, including, but not limited to internet content related to news, sports, stock market data, online retailers, or any additional internet content available within internet 1360 and apparent to one skilled in the art.

In an embodiment, first streamer 1322, second streamer 1324, and third streamer 1326 display exclusive content from one or more particular web sites. Further, in additional embodiments, the one or more web sites may purchase a right to display such exclusive content from a distributor or developer of the graphical user interface, a licensee of the distributor or developer of the graphical user interface, or any other party designated by the distributor or developer on a pay per view basis, a click-through basis, or using any other economic structure apparent to one skilled in the art. For example, first website 1362 may purchase a right to display exclusive content on first streamer 1322, second website 1364 may purchase a right to display exclusive content on second streamer 1324, and fourth website 1368 may purchase a right to display exclusive content on third streamer 1326. One skilled in the art would recognize that any website within internet 1360 may purchase a right to display such exclusive content within one or more streamers, including, but not limited to a third website 1366 and a nth website 1369, without departing from the spirit or scope of the present invention.

In an embodiment, respective websites may pay a premium to display their content within streamers that are prominently visible to the user of graphical user interface 1300. For example, a price paid by first website 1362 to display content on first streamer 1322 may be higher than a corresponding price paid by second website 1364 to display content on second streamer 1324, which may also be higher than a corresponding price paid by fourth website 1368 to display content on third streamer 1326.

However, the present invention is not limited to streamers that display exclusive online content. In an embodiment, a single streamer, such as first streamer 1322 (or any additional streamer within streamers 1320), can display a combination of online content from one or more websites, e.g., first website 1362, second website 1364, third website 1366, and fourth website 1368. In such an embodiment, a respective website, such as first website 1362, may pay a premium to have its content displayed at a certain frequency within a respective streamer.

Additionally, one or more of streamers 1320 can be a dedicated streamer that displays similar online content from one or more Internet sources (e.g., a streamer, such as first streamer 1322, may display only sports-related online content). In such an embodiment, a respective website, such as first website 1362, may pay a fee to a distributor or developer of the graphical user interface, a licensee of the distributor or developer of the graphical user interface, or any other party designated by the distributor or developer to have its online content interspersed within a dedicated streamer. Further, the fee paid by the respective website to have its online content interspersed within a dedicated streamer may vary depending on the relevance of the displayed online content to that of the dedicated streamer (i.e., the fee may increase if the online content of the respective website is especially similar to that displayed in the dedicated streamer).

In an additional embodiment, a user may select online content to be displayed on any combination of first streamer 1322, second streamer 1324, third streamer 1326, or any other streamer apparent to one skilled in the art. For example, while first streamer 1322 may be configured by default to display online content from Amazon.com, the user may reconfigure first streamer 1322 to display online content ESPN (or any other source of online content available to the user and apparent to one skilled in the art). In an additional embodiment, the user may purchase the right to modify the content displayed by one or more streamers from a distributor or developer of the graphical user interface, a licensee of the distributor or developer of the graphical user interface, or any other party designated by the distributor or developer.

A fourth streamer 1328 and a fifth streamer 1330 of streamers 120 are configured, respectively, to display words or phrases associated with links to locally-stored electronic assets or additional electronic assets received in real-time by a computer system of the user. For example, fifth streamer 128 may display links to electronic assets, such as an email messages, files, tasks, or calendars appointment related to a present or past date, that have been “time shifted” into the future for action at a later time, as described above with reference to FIG. 1. Further, sixth streamer 130 can display links to any number of electronic assets stored locally on the computer system of the user, including, but not limited to email messages, appointments, tasks, text or voice mail messages, digital images, videos, and documents, without departing from the spirit or scope of the present invention.

In the embodiment of FIG. 13A, a proxy server 1350 serves as an interface between graphical user interface 1300 (i.e., links to online content displayed by first streamer 1322, second streamer 1324, and third streamer 1326) and the respective sources of online content within internet 1360 (e.g., first website 1362, second website 1364, and fourth website 1368). For example, when a user clicks on an embedded link 1322a in first streamer 1322, a request is transmitted to proxy server 1350, which records the request and forwards the request to first website 1362.

First website 1362 subsequently forwards the requested information (e.g., a webpage) corresponding to embedded link 1322a to graphical user interface 1300, which displays the received information to the user through a window 1388 of an embedded browser. In an embodiment, information corresponding to embedded link 1322a is transmitted from first website 1362 to graphical user interface 1300 via proxy server 1350, as shown by dashed connector 1350a in FIG. 13A. However, in additional embodiments, the proxy server brokers the initial request and the subsequent transfer of data occurs directly between the first website 1362 and graphical user interface 1300, as shown by dashed connector 1362a in FIG. 13A.

FIG. 13B illustrates additional features of the interface between graphical user interface 1300 and the respective sources of online content, as depicted in FIG. 13A. In the embodiment of FIG. 13B, bar 1302 includes a plurality of group-level cards 1304, such as a “Music and Pictures” cards 1306 linked to locally-stored digital music files, images, and videos; a “Documents” card 1308 linked to locally-stored documents; a “Bookmarks and Web” card 1310 linked to locally-stored web bookmarks and URLs; a “Communicator” card 1312 linked to locally-stored emails, instant messages, and shared cards; a “Stuff to Transfer” card 1314 linked to locally-stored cards to be transferred to additional users; and an “Amazon.com” card 1316 linked to at least a stored URL that opens an embedded browser displaying online content from Amazon.com.

Further, one or more group-level cards within bar 1302 may be linked, respectively, to a corresponding set of subgroup-level cards and/or asset-level cards. For example, in FIG. 13B, a user clicks within a click region (not shown) of “Bookmarks and Web” card 1310, thereby exposing a corresponding set of asset-level cards (and potentially, subgroup-level cards) associated with card 1310. In FIG. 13B, the corresponding asset-level cards include asset-level cards 1310a through 1310d, which are associated, respectively, with one or more bookmarks stored locally on the computer system of the user, and asset-level card 1310e, which is associated with a stored URL of website 1362.

When the user clicks on asset-level card 1310e associated with a stored URL of website 1362, a request is transmitted to proxy server 1350, which records the request and forwards the request to website 1362. First website 1362 subsequently forwards the requested information back to the graphical user interface, which displays the received information to the user through a window 1388 of an embedded browser. As described above, the requested information can be transmitted from first website 1362 to the user via proxy server 1350, as shown by dashed connector 1350a in FIG. 13A. However, in additional embodiments, the proxy server can broker the initial request and the subsequent transfer of data can occur directly between the first website 1362 and graphical user interface 1300, as shown by dashed connector 1362a in FIG. 13A.

In the embodiments of FIGS. 13A and 13B, proxy server 1350 serves as an interface between graphical user interface 1300 (i.e., links to online content displayed by streamers 1320) and the respective sources of online content within internet 1360. However, the present invention is not limited to such interfaces, and in additional embodiments, graphical user interface 1300 can directly access the respective sources of online content within internet 1360 through links in streamers 120 without first passing through proxy server 1350. For example, a user may click on embedded link 1322a in first streamer 1322 to directly transmit a request to first website 1362 through internet 1360, as shown by solid connector 1360a. In contrast to the embodiments described above, information corresponding to embedded link 1322a is transmitted directly from first website 1362 to graphical user interface 1300, as shown by dashed connector 1360b in FIG. 13A. In such an embodiment, proxy server 1350 neither records or brokers the request for information between graphical user interface 1300 and first website 1362.

The embodiments of FIGS. 13A and 13B, the user accesses online information by clicking within a specific region of the graphical user interface 1300. However, and as described above, the present invention is not limited to such user actions. In additional embodiments, the user may access online content, e.g., content associated with an embedded link in a streamer or content associated with an asset-level card in a bar, using any actionable input apparent to one skilled in the art, including, but not limited to, one or more keystrokes, a voice command, or the use of touch.

As described above in reference to FIG. 1, graphical user interface 1300 may incorporate one or more additional tracking technologies to supplement the tracking capability of proxy server 1350. In such embodiments, the additional tracking technology may monitor not only the online activity of the user, but also any activity of the user involving graphical user interface 1300 that does not require the internet (e.g., offline activities such as viewing locally-stored electronic assets via a group level card or activating a link to a locally-stored electronic asset on a streamer).

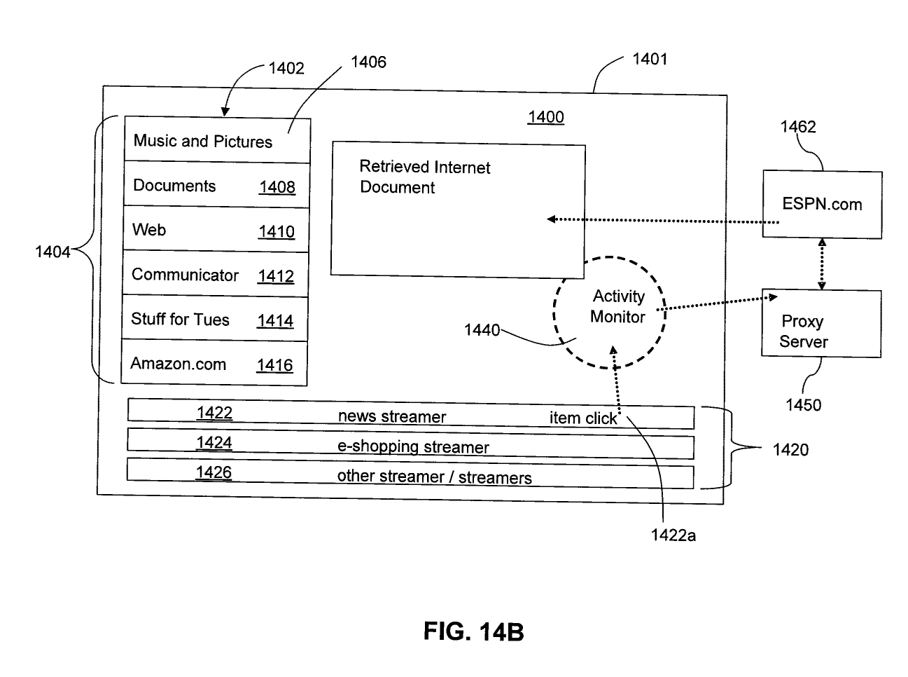

FIGS. 14A and 14B depict an exemplary activity monitor that cooperates with a proxy server to collectively track actions of a user of a graphical user interface 1400, according to an embodiment of the present invention. In FIG. 14A, graphical user interface 1400 includes a bar 1402 having a plurality of group-level cards, shown generally at 1404, and a set of elongated streamers, shown generally at 1420. In the embodiment of FIG. 14A, graphical user interface 1400 is configured to be viewed on a large screen display 1401, including, but not limited to, displays characteristic of computer monitors, laptop computers, and televisions, such as those with “large screen” displays, high-definition (HD) displays, or combinations thereof.

Similar to the embodiment of FIG. 13B, the plurality of group-level cards 1404 includes a “Music and Pictures” card 1406, a “Documents” card 1408, a “Web” card 1410, a “Communicator” card 1412, a “Stuff for Tues.” 1414, and an “Amazon.com” card 1416. Further, streamers 1420 include a first streamer 1422, a second streamer 1424, and a third streamer 1426, which respectively display different types of data to the user.

For example, first streamer 1426 may be configured to display online content including links to a website of a news organization, and second streamer 1424 may be configured to display online content including links to a website of an online retailer (e.g., Amazon.com) or any online advertiser, including, but not limited to, a commercial company such as Hyatt Hotels, an airline, or an automobile company such as Lexus. Third streamer 1426 may be configured to display any combination of links to internet content and links to locally-stored electronic assets or additional electronic assets received by a computer system of the user in real time. In additional embodiments, streamers 1420 may include any number of individual streamers configured, respectively, to display any combination of links to online content and electronic assets, locally-stored or otherwise, that would be apparent to one skilled in the art.

In FIG. 14A, an activity monitor 1440 associated with graphical user interface 1400 collects information on user actions involving a group-level card within bar 1402, user actions involving a subgroup-level card or asset-level card associated with a group level card within bar 1402, and user actions involving links within one or more of first streamer 1422, second streamer 1424, and third streamer 1426. As such, activity monitor 1440 collects information not only on the user's online Internet activity, but also on any offline activity of the user that involves graphical user interface 1400.

For example, activity monitor 1440 may track a frequency at which the user clicks on or hovers over a specific group-level, subgroup-level, or asset-level card in bar 1402. Additionally or alternatively, activity monitor 1402 may collect information on specific electronic assets viewed or previewed by the user (e.g., a file name of the electronic asset and the type of electronic asset, etc.). Activity monitor 1440 may also track a frequency at which the user accesses links within one or more streamers and, additionally or alternatively, tracking monitor 1440 may obtain information on specific online content accessed by the user. In additional embodiments, tracking monitor 1440 may collect information on any online or offline user activity involving graphical user interface 1400 without departing from the spirit or scope of the present invention, which would be apparent to one skilled in the art.

Activity monitor 1440 subsequently transmits the collected data to a background process, or daemon, associated with graphical user interface 1400, which processes the received information and transmits the processed information to a proxy server 1450, which serves as an interface between graphical user interface 1400 and the internet, e.g., URL/URLs 1460. In an embodiment, the background process may transmit the processed information to proxy server 1450 continuously, or alternatively, the background process may transmit the processed information through regular, discrete reports to proxy server 1450. In an embodiment, proxy monitor may transmit the received information to one or more third parties, such as online retailers or advertisers, who may use the information to target advertising and/or online content to the user (e.g., through on-line shops in a desktop mall, as described in detail below in reference to FIG. 17).

FIG. 14B schematically depicts an exemplary process through which a user accesses online content in the graphical user interface of FIG. 14A, according to an embodiment of the present invention. In FIGS. 14A and 14B, similar elements are similarly identified, and a single description is provided above for these similar elements in FIG. 14A.

In FIG. 14B, the user clicks on an embedded link 1422a in first streamer 1422, thereby generating a request that is transmitted to proxy server 1450. However, in contrast to the embodiment of FIG. 13A, the generated request is tracked by activity monitor 1440, which collects information on the request, prior to its transmission to proxy server 1450. Proxy server 1450 then records the request and forwards the request to a website 1462 associated with embedded link 1422a. First website 1462 subsequently forwards the requested information to graphical user interface 1400, which displays the received information to the user through a window 1488 of an embedded browser.

For example, embedded link 1422a may be linked to a URL address associated with the ESPN website. In such an embodiment, tracking monitor 1440 may record any combination of a frequency at which the user has requested embedded link 1422a, a frequency at which the user has requested any embedded link associated with the ESPN website, and a frequency at which the user has accessed links displayed within first streamer 1422 (or any additional streamer). Activity monitor 1440 subsequently transmits the collected information to the background process associated with graphical user interface 1400, which processes the received information and transmits the processed information to proxy server 1450, thereby supplementing the information recorded by proxy server 1450.

In the embodiments described herein, activity monitor 1440, when used in conjunction with proxy server 1450, provides graphical user interface 1400 an ability to monitor and collect data on not just the user's internet activity, but on all of the user's offline activities. Therefore, a comprehensive activity profile can be developed for each user of graphical user interface 1400, which, in an embodiment, can be used to target ads and other relevant information to the user with pinpoint accuracy. In such an embodiment, the activity profile can direct the user to information or information objects, both locally- and remotely-accessible, that the user is likely to find interesting.

In the embodiments of FIGS. 14A and 14B, proxy server 1450 serves as an interface between graphical user interface 1400 (i.e., links to online content displayed by streamers 1420) and the respective sources of online content within internet 1460. However, the present invention is not limited to such interfaces, and in additional embodiments, graphical user interface 1400 can directly access the respective sources of online content within internet 1460 through links in streamers 1420 without first passing through proxy server 1450.

### EXAMPLE 2

### Targeting Online Content to a User of a Graphical User Interface

The graphical user interfaces described above serve as convenient vehicles with which online retailers can deliver targeted advertising and internet content to a user. In the embodiments described above, such targeted advertising may be generated based on an online activity of the user recorded by a proxy server, such as proxy server 1350 of FIGS. 13A and 13B, and on an off-line activity of the user, which does not involve the internet and which is recorded by an activity monitor, such as activity monitor 1440 of FIGS. 14A and 14B. As described above, such targeted advertising may be delivered to the user through one or more streamers, such as streamers 120 of FIG. 1, or through one or more user-actionable group-level, subgroup-level, or asset-level cards within a bar, such Web card 116 in bar 102 of FIG. 1. However, in additional embodiments, the graphical user interfaces described above may also deliver targeted advertising to a user in a non-streaming form that is visible to the user without any additional action.

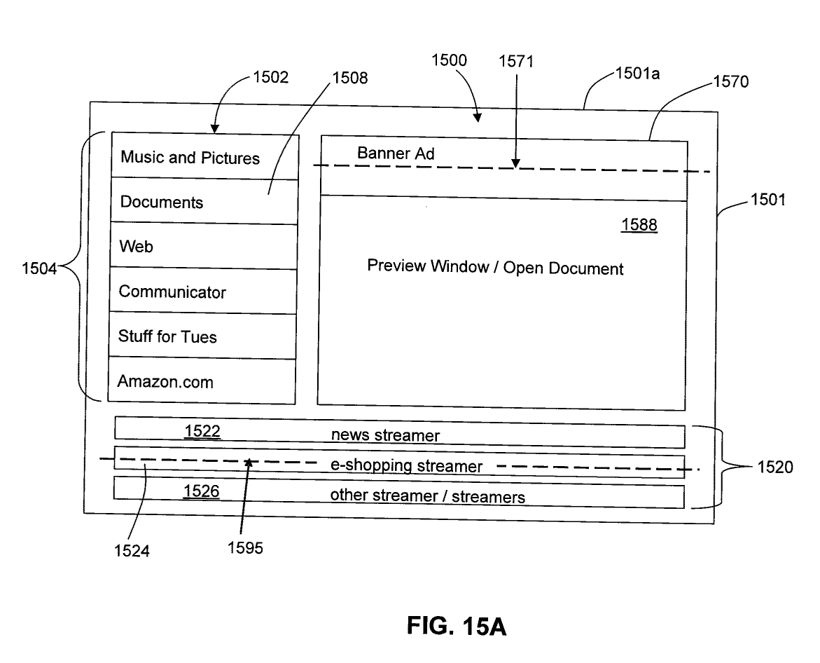

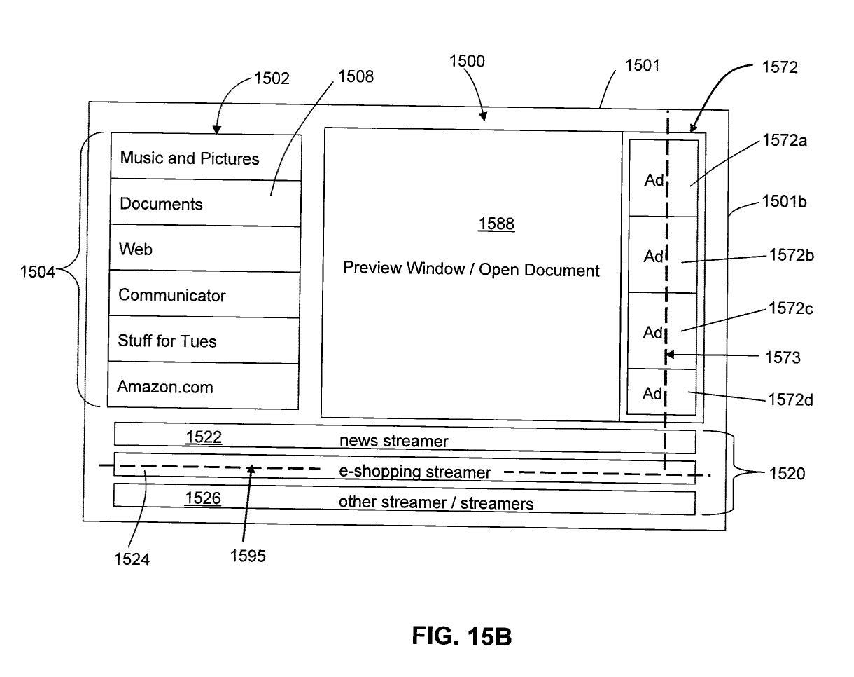

FIGS. 15A and 15B schematically depict a graphical user interface 1500 that delivers targeted advertising to a user, according to an embodiment of the present invention. In the embodiments of FIGS. 15A and 15B, the targeted advertising can include any combination of graphical advertisements, textual advertisements, banner advertisements, audio advertisements, video advertisements, and any other multimedia-based advertisement apparent to one skilled in the art. In FIGS. 15A and 15B, graphical user interface 1500 includes a bar 1502 having a plurality of group-level cards, shown generally at 1504, and a set of elongated streamers, shown generally at 1520. In the embodiment of FIG. 15A, graphical user interface 1500 is configured to be viewed on a large screen display 1501, including, but not limited to, displays characteristic of computer monitors, laptop computers, and televisions, such as those with “large screen” displays, high-definition (HD) displays, or combinations thereof.

Streamers 1520 includes a first streamer 1522, a second streamer 1524, and a third streamer 1526, which respectively display different types of data to the user. For example, first streamer 1522 may be configured to display online content including links to a website of a news organization; second streamer 1524 may be configured to display online content including links to a website of a online or online retailer; and third streamer 1526 may be configured to display any combination of links to internet content, locally-stored electronic assets, or additional electronic assets received by a computer system of the user in real-time. Further, the present invention is not limited to such combination of streamers, and in additional embodiments, streamers 1520 may include any number in individual streamers configured, respectively, to display any combination of links to online content and electronic assets that would be apparent to one skilled in the art.

In FIG. 15A, graphical user interface 1500 includes an elongated banner advertisement 1570 that delivers targeted advertising and online content to the user. In an embodiment, banner advertisement 1570 includes advertisements and content from online retailers or other third parties that are targeted to the user based on a user's recorded online or offline activity, which may be reported to the online retailer or other third parties by a proxy server, as described above.

In an embodiment, elongated banner advertisement 1570 can be positioned such that an elongated axis 1571 of banner advertisement 1570 is parallel to an axis 1595 of streamers 1520. Further, banner advertisement 1570 is disposed within display 1501 such that banner advertisement 1570 is proximate to edge 1501a of large display 1501 and does not block any portion of bar 1502. However, the present invention is not limited to such configurations, and in additional embodiments, banner advertisement 1570 may be positioned at any other suitable location within display 1501 without departing from the spirit or scope of the present invention.

Further, in the embodiment of FIG. 15A, banner advertisement 1570 remains visible to the user despite any actions taken by the user. For example, the user may hover a mouse pointer over a hover region of “Documents” card 1508 to display a preview of a electronic asset associated with card 1508 in a large window, shown generally at 1588. Alternatively, the user may click within a click region (not shown) of card 1508, thereby opening the electronic asset associated with card 1508 in a large window, also shown generally at 1588. In either case, regardless of whether the user previews the electronic asset in window 1588 or opens the electronic asset in window 1588, banner advertisement 1570 remains visible to the user.

In an embodiment, banner advertisement 1570 may include a combination of text, images, digital video, and or sound. Further, in an additional embodiment, banner advertisement 1570 may include one or more links to a website of one or more online sites, including, but not limited to, online retailers. Alternatively, any portion of banner advertisement 1570 may be an embedded link to one or more online retailers or other parties. For example, a portion of banner advertisement 1570 may be an embedded link to an online retailer, such as Amazon.com, or an embedded link to another party that may not make or complete purchases online. As described above, the user may position a mouse point over an embedded link within banner advertisement 1570 and subsequently click on that embedded link, thereby transmitting a request that, in an embodiment, is tracked by an activity monitor and recorded by a proxy server before being transmitted to the corresponding website. The requested information (e.g., a webpage) would then be displayed to the user within window 1588.

Further, in an additional embodiment, an online retailer or other party may purchase a right to display content within banner advertisement 1570 from a distributor or developer of the graphical user interface, a licensee of the distributor or developer of the graphical user interface, or any other party designated by the distributor or developer. Further, the cost of banner advertisement 1570 may depend upon a frequency at which the user (or users) accesses an embedded link within the text ad, as collected and reported by any combination of an activity monitor and a proxy server.

FIG. 15B schematically depicts an additional embodiment of graphical user interface 1500 of FIG. 15A that delivers targeted advertising to the user. In contrast to the embodiment of FIG. 15A, graphical user interface 1500 of FIG. 15B delivers targeted advertising through one or more advertisements whether text, video, audio or otherwise, shown generally at 1572, that are positioned along an elongated axis 1573 and proximate to edge 1501b of display 1501. Further, in FIG. 15B, text advertisements 1572 are positioned within display 1501 such that elongated axis 1573 is perpendicular to the elongated axis 1595 of streamers 1520 and such that text advertisements 1572 block no portion of streamers 1520.

As described above, text advertisements 1572 can remain visible to a user regardless of any action on the part of the user. For example, the user may preview or open an electronic asset associated with “Documents” card 1508 within large window 1588, or alternatively, the user may view online content from an embedded link within window 1588 of an embedded browser. In such embodiments, text advertisements 1572 remains visible to the user regardless of the content displayed within window 1588.

In the embodiment of FIG. 15B, text advertisements 1572 include individual text advertisements 1572a, 1572b, 1572c, and 1572d. In an embodiment, each text advertisement may correspond to a different advertiser, and each text advertisement may incorporate one or more links corresponding to the respective advertisers. As described above, the user may position a mouse point over an embedded link within a respective text advertisement and subsequently click on that embedded link, thereby transmitting a request that, in an embodiment, is tracked by an activity monitor and recorded by a proxy server before being transmitted to the corresponding website. The requested information (e.g., a webpage) would then be displayed to the user within window 1588.

Further, in an additional embodiment, an online retailer may purchase a right to display content within an individual text advertisement from a distributor or developer of the graphical user interface, a licensee of the distributor or developer of the graphical user interface, or any other party designated by the distributor or developer. The price paid to display online content within a text advertisement may depend on the visibility of the advertisement (e.g., a price for text advertisement 1572a may be higher or lower than a price for text advertisement 1572c, which is positioned closer to streamers 1520) and on the size of the advertisement (e.g., a price paid for text advertisement 1572d may be lower or higher than that paid for text advertisements 1572a, 1572b, or 1572c, respectively). Further, in additional embodiments, the price of a text advertisement may depend upon a frequency at which a user (or users) access an embedded link within the text ad, as collected and reported by any combination of an activity monitor or a proxy server.

### EXAMPLE 3

### Sharing Electronic Assets Between Users of a Graphical User Interface

Users of the exemplary graphical user interfaces described herein, such as graphical user interface 100 of FIG. 1, may choose to electronically share group-level cards, subgroup-level cards, and asset-level cards with other users of the graphical user interface. Unlike email attachments, such electronically-shared cards are constructed by users who periodically link electronic assets to the shared card or cards by dragging and releasing electronic assets, including asset-level cards and subgroup-level cards, onto shared cards using any of the techniques described above. In additional embodiments, electronic assets, including asset-level cards and subgroup-level cards, can be linked to the shared card or cards through any additional user action apparent to one skilled in the art, such as the use of voice, the use of touch, or combinations thereof, without departing from the spirit or scope of the present invention. As such, these shared cards include the electronic assets respectively linked to them, and may also include the hierarchical structure that describes the linked electronic assets.

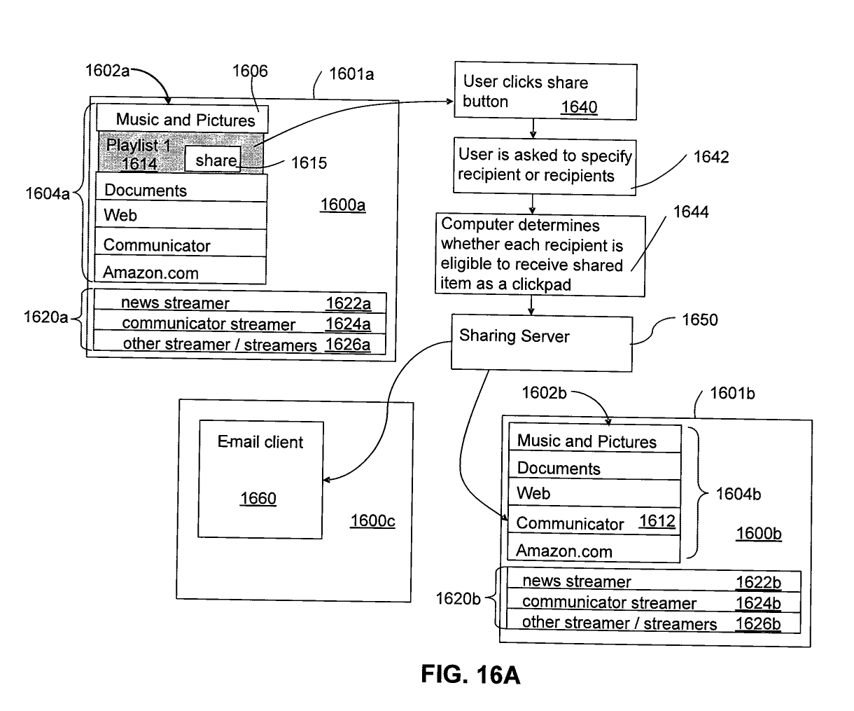

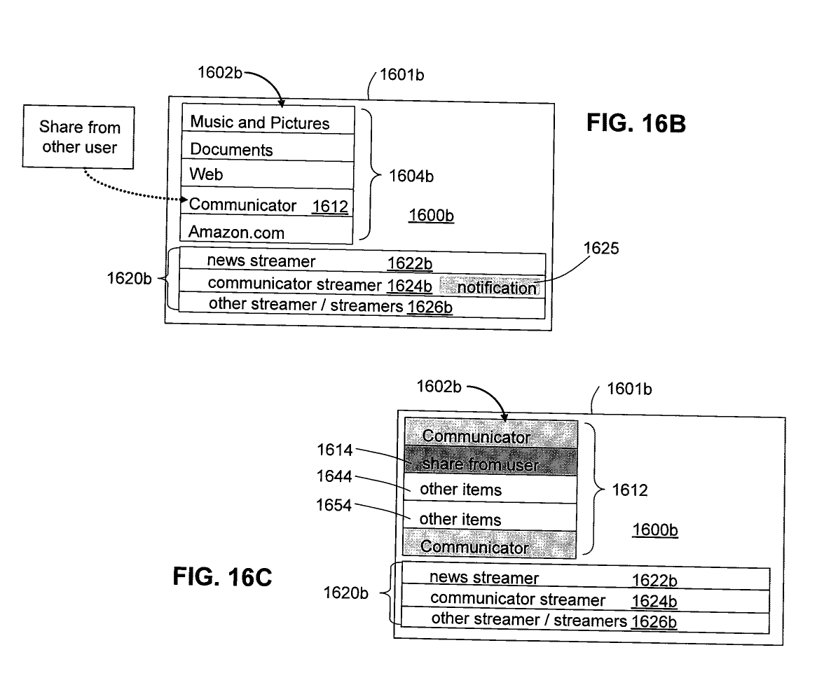

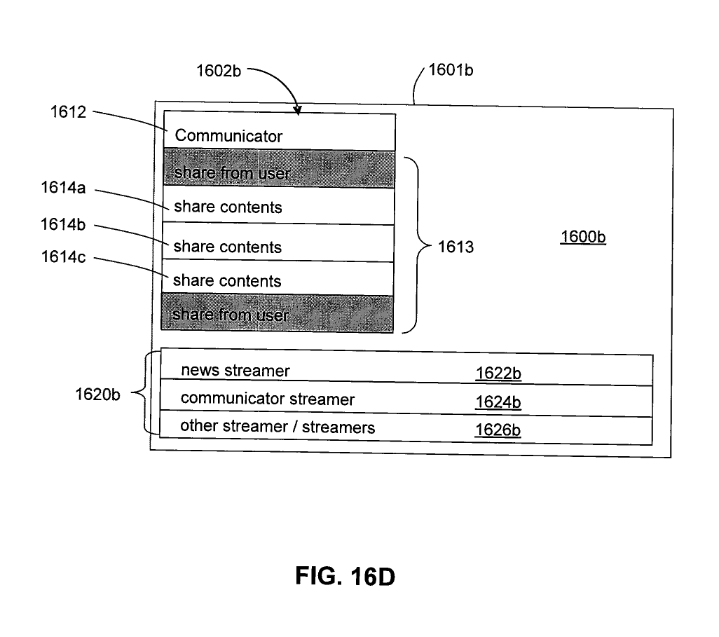

FIGS. 16A-16D depict an exemplary process by which a user of a graphical user interface 1600a electronically shares linked electronic assets with one, or more individuals who may or may not be users of the graphical user interface, according to an embodiment of the present invention. In FIGS. 16A-16D, graphical user interface 1600a includes a bar 1602a having a plurality of group-level cards, shown generally at 1604a, and a set of elongated streamers, shown generally at 1620a. In the embodiment of FIG. 16A-16D, graphical user interface 1600a is configured to be viewed on a large screen display 1601, including, but not limited to, displays characteristic of computer monitors, laptop computers, and televisions, such as those with “large screen” displays, high-definition (HD) displays, or combinations thereof. However, the present invention is not limited to such large screen displays, and in additional embodiments, the graphical user interfaces depicted in FIGS. 16A-16D can be viewed on the large-screen displays described, small-screen displays, including, but not limited to, display screens of smart phones, PDAs, remote controls, a computer navigational device, such as a mouse, or any additional displays apparent to one skilled in the art.

Streamers 1620a includes a first streamer 1622a, a second streamer 1624a, and a third streamer 1626a, which respectively display different types of data to the user. For example, first streamer 1622a may be configured to display online content including links to a website of a news organization, while third streamer 1626a may be configured to display any combination of links to internet content, locally-stored electronic assets, or additional electronic assets received by a computer system of the user in real-time. However, unlike the embodiments of FIGS. 15A and 15B, second streamer 1624a is configured to display to the user information regarding electronic assets that have been electronically shared between users of graphical user interface 1600a. As described above, and in additional embodiments, streamers 1620a may include any number of individual streamers configured, respectively, to display any combination of links to online content and electronic assets, including those electronic assets locally-stored on a computer of the user and those electronic assets remotely-stored on a computer accessible to the user, without departing from the spirit or scope of the present invention,

FIG. 16A depicts an exemplary process through which a user of graphical user interface 1600a electronically shares any combination of group-level cards and asset-level cards of bar 1602a, according to an embodiment of the present invention. In step 1640, the user positions a mouse pointer within a region 1615 (hereinafter referred to as a “share region”) of a card 1614. Upon clicking within share region 1615, the user initiates a process through which card 1614 (and an associated hierarchy of the grouped and linked electronic assets) is shared with others who may or may not be users of the graphical user interface. Although not depicted in FIG. 16A, share region 1615 can be surrounded by a buffer zone that incorporates an additional area of space responsive to clicking by a mouse pointer. Further, in additional embodiments, share region 1615 (and any corresponding buffer region) may also be responsive any actionable input apparent to one skilled in the art, including, but not limited to, one or more keystrokes, a voice command, or the use of touch.

In the embodiment of FIG. 16A, card 1614 is an subgroup-level card (e.g., a “Playlist 1” card) that is associated within one or more locally-stored electronic assets (e.g., digital music files, MP3 files, etc. within Playlist 1), and subgroup-level card 1614 is linked to a corresponding group-level card 1606 (e.g., a “Music and Pictures” card) within bar 1602a. However, the exemplary process depicted in FIG. 16A is not limited to electronically sharing sub-group level cards, and in additional embodiments, the process depicted herein may be applied to any asset-level card, subgroup-level card, or group-level card within bar 1602a without departing from the spirit or scope of the present invention.

Once the user has initiated the sharing process in step 1640, the user then specifies, in step 1642, an identity of one or more recipients with whom card 1614 will be shared. For example, the first user could specify a name of an intended recipient, an email address of an intended recipient, an instant messaging username for an intended recipient, or any other suitable identifying information apparent to one skilled in the art.

In step 1644, graphical user interface 1600a, in conjunction with the computer system of the user, determines whether each specified recipient is a user of the graphical user interface and as such, is able to leverage the functionality of the card 1614 and the hierarchical structure of the card 1614. Once the determination is made for each user in step 1644, card 1614 is passed to a sharing server 1650, which subsequently delivers card 1614 to each specified recipient. In an additional embodiment, the transmittal may occur directly between the user and one or more recipients without use of a sharing server 1650.

For example, if a specified recipient were a user of the graphical user interface, sharing server 1650 transmits card 1614, and any additional asset-level or subgroup-level cards linked to shared card 1614, to the specified recipient. Once received by the specified recipient, a graphical user interface 1600b of the specified recipient links newly-received card 1614 within a “Communicator” card 1612 within a bar 1602b of graphical user interface 1600b and may display an alert within a “Communicator” streamer 1624b of graphical user interface 1600b, with or without an audible sound or indicator, as described in detail below with reference to FIGS. 16B-16D. As such, the specified user is able to leverage the functionality of shared card 1614 and the hierarchical structure inherent to shared card 1614, while also obtaining access to electronic assets associated with shared card 1614.

However, if the specified recipient were not a user of the graphical user interface, sharing server 1650 can bundle card 1614 and any electronic assets linked to shared card 1614 into an email attachment or attachments, which can be send to an email client 1660 of the specified recipient. In such an embodiment, the specified recipient obtain the electronic assets associated with card 1614, but the recipient will be unable to leverage the functionality of the shared card and the hierarchical structure of shared card 1614. In an additional embodiment, the transmittal may occur directly between the user and one or more recipients without use of a sharing server 1650.

In the embodiment of FIG. 16A, sharing server 1650 electronically transmits card 1614 to a single, specified recipient. However, the present invention is not limited to electronically sharing cards between two users, and in an additional embodiment, the user may electronically share card 1614 with any number of specified recipients, which may or may not be users of the graphical user interface, without departing from the spirit or scope of the present invention.

FIGS. 16B, 16C, and 16D depict an exemplary process through which a user of graphical user interface 1600b receives a shared card, according to an embodiment of the present invention. FIGS. 16A, 16B, 16C, and 16D respectively depict similar elements that are similarly identified, and a single description is provided above for these similar elements in reference to FIG. 16A.

In FIG. 16B, a card 1614 is received by the user and is linked by graphical user interface 1600 to a “Communicator” card 1612 associated with the user. Further, once card 1614 is received by graphical user interface 1600b, a notification 1625 to the user may be displayed within “Communicator” streamer 1624b. In such an embodiment, graphical user interface 1600b treats the receipt of a shared card from a user in a manner similar to the treatment of received emails and received instant messages, which are similarly organized under “Communicator” card 1612.

Once the user becomes aware of newly-received shared card 1614, the user clicks within a click region (not shown) of “Communicator” card 1612 to expose those lower-level cards associated with “Communicator” card 1612, as depicted in FIG. 16C. In FIG. 16C, a number of lower-level cards are associated with “Communicator” card 1612 and exposed by the actions of the user, including shared card 1614 and additional cards 1644 and 1654 that may represent email, instant messages, or previously-shared cards. In additional embodiments, “Communicator” card 1612 may be linked to any number of lower-level cards representing any of a number of communicated electronic assets without departing from the spirit or scope of the present invention.

In the embodiment of FIG. 16C, newly-arrived shared card 1614 is positioned at the top of the stack of lower-level cards associated with “Communicator” card 1612. However, the present invention is not limited to such configurations, and in additional embodiments, shared card 1614 may be located at an alternate location within the stack of lower-level cards associated with “Communicator” card 1612.

The user may then click within a click region (not shown) of shared card 1614 to display those asset-level cards (and potentially, subgroup-level cards), linked to shared card 1614, as depicted in FIG. 16D. In the embodiment of FIG. 16D, shared card 1614 is associated with asset-level cards 1614a, 1614b, and 1614c that, respectively, are linked to corresponding electronic assets. Once the user views those asset-level cards (and potentially subgroup-level cards) associated with shared card 1614, the user may accept or reject each new card by clicking on an appropriate box on each card (not shown).

In an additional embodiment, the user may click within a click region of any subgroup-level card associated with shared card 1614 to display those lower-level cards associated with the respective subgroup-level card. In such an embodiment, the user may accept or reject the entire subgroup-level card by any of a number of means apparent to one skilled in the art, including, but not limited to, checking an appropriate box. Alternatively, the user may selectively accept or reject electronic assets linked to the subgroup-level card, which itself is linked to shared card 1614.

In FIG. 16C, the user clicks on “Communicator” card 1612 to expose those lower-level cards associated with “Communicator” card 1612. However, the present invention is not limited to such functionality. In an additional embodiment, upon clicking on “Communicator” card, may view directly those asset-level cards (and subgroup-level cards) linked to newly-received shared card 1614 and may directly accept or reject these shared electronic assets, as depicted in FIG. 16D, without first viewing those lower-level cards are associated with “Communicator” card 1612.

In an embodiment, a user who is sending a shared card (e.g., card 1614) may have the option of sharing continuously, i.e., the graphical user interface will automatically update the shared card on the computer of the specified recipient or recipients to reflect changes made by the user. Additionally, a document or card may be shared among a plurality of users in such a manner that the user interface system will automatically update changes to the document or card made by any user.

### EXAMPLE 4

### Accessing an Electronic Shopping Mall through a Graphical User Interface

Individual cards of the graphical user interfaces described herein may manage of one or more stored electronic assets, such as stored URLs, that are accessible to a user. For example, and as described above in reference to FIGS. 14A and 14B, a bar, such as bar 1402, may include a card, such as “Amazon.com” card 1418, that is linked to a URL of a particular website. Once the user clicks the click region of such a card, a request is brokered through a proxy server to the website, and the requested webpage is subsequently opened within a window of an embedded browser associated with the graphical user interface.

In an embodiment, a group-level card within a bar of a graphical user interface may manage a number of additional subgroup-level cards and asset-level cards that collectively form an “walk-in′ electronic mall or groups of shops.” In such an embodiment, each lower-level card directly linked to such a group-level card may represent an individual “shop” associated with a website, and each respective “shop” (e.g., lower-level card linked directly to the group-level card) may offer merchandise or services ordinarily associated with the website. Further, at least a portion of the information ordinarily available on a website corresponding to an individual “shop” may be imported into the graphical user interface on demand or asynchronously in the background and made available to the user within the “shop.”

FIG. 17 depicts an exemplary process through which a user of a graphical user interface 1700 may access an electronic “shopping mall,” according to an embodiment of the present invention. In FIG. 17, graphical user interface 1700 includes a bar 1702 having a plurality of cards, shown generally at 1704, and a set of elongated streamers, shown generally at 1720. In the embodiment of FIG. 17, graphical user interface 1700 is configured to be viewed on a large screen display 1701, including, but not limited to, displays characteristic of computer monitors, laptop computers, and televisions, such as those with “large screen” displays, high-definition (HD) displays, or combinations thereof.

Further, streamers 1720 includes a first streamer 1722, a second streamer 1724, and a third streamer 1726, which respectively display different types of data to the user. For example, first streamer 1722 may be configured to display online content including links to a website of a news organization; second streamer 1724 may be configured to display online content including links to a website of a online or online retailer; and third streamer 1726 may be configured to display any combination of links to internet content, locally-stored electronic assets, or additional electronic assets received by a computer system of the user in real time. In additional embodiments, streamers 1720 may include any number of individual streamers configured, respectively, to display any combination of links to online content and electronic assets that would be apparent to one skilled in the art.

However, unlike the embodiments described above, bar 1702 includes a “Mall” card 1717 linked to one or more subgroup-level cards that, respectively, are associated with a respective website of an online retailer and that correspond to, respectively, individual shops within an electronic “shopping mall.” In FIG. 17, the user clicks within a click region (not shown) of Mall card 1717, whereupon Mall card 1717 splits to expose subgroup-level “shop” cards respectively linked to Mall card 1717, including an “ebay.com” shop card 1772, an “amazon.com” shop card 1774, a “netflix.com” shop card 1776, and a generic “other” shop card 1778. Although not depicted in FIG. 17, a subgroup-level card associated with one or more coupon website (e.g., a website that provides user downloadable coupon and/or pointers to discounted items) may be linked to Mall card 1717 in an additional embodiment.

Upon clicking on “amazon.com” shop card 1774, card 1774 opens to reveal an additional layer of subgroup-level “department” cards that, respectively, represent one or more “departments” within the corresponding website. For example, “amazon.com” shop card 1774 may be linked to one or more asset level cards 1774a (e.g., “War and Peace”), and or one or more department cards (e.g., “DVDs” 1774b, and “other Amazon department” 1774c). In an embodiment, each “department” card may be clicked open by clicking within a click region of the respective department card, or alternatively, each department card may be searched for content.

For example, the user may invoke a purchasing process by clicking on the “War and Peace” card 1774a or may click open a department card linked to the respective shop card to reveal one or more an asset-level cards corresponding to the department. In an additional embodiment, clicking open any other department card linked to a respective shop card can reveal one or more asset-level cards corresponding to, respectively, recommended items available for purchase, hot sellers, or any other item apparent to one skilled in the art. The recommended books, items, specials, or hot sellers may be targeted directly to the user based on information forwarded to the corresponding website by a proxy server associated with graphical user interface 1700. Further, information obtained by clicking open a department card may be downloaded by graphical user interface 1700 on demand, or alternatively, the information may have been downloaded asynchronously in the background by graphical user interface 1700.

In an additional example, the user may search books department card 1704a (or any additional department card linked to the respective shop card) for content. In such an embodiment, graphical user interface 1700 submits a search request to the corresponding website via the proxy server (not shown), and the search results may be displayed to the user within a window (not shown).

Further, although not depicted in FIG. 17, clicking open a shop card, such as “amazon.com” shop card 1774, may also reveal one or more asset-level cards that, respectively, correspond to a special offer available on the corresponding website. In an embodiment, these special offers may be targeted to the user based on information collected by the proxy server and forwarded to the corresponding website. Each “special offer” card may be associated with a stored URL linked to the corresponding web site, and by clicking on the respective special offer card, the graphical user interface submits a request to the corresponding website through the proxy server (not shown). The requested web page is subsequently opened in a window of an embedded browser of graphical user interface 1700. Alternatively, by hovering over a hover region of the special offer card, a preview of the special offer card may be obtained, as described above.

In an embodiment, the set of electronic shops associated with Mall card 1717 may be selected by the user and additionally or alternatively, may be modified wholly or partly by actions of the user. In a further embodiment, an online retailer, such as EBay.com, or other commercial company, such as a hotel company or an automobile manufacturer, may purchase a right to display content within the electronic “shopping mall” from a distributor or developer of the graphical user interface, a licensee of the distributor or developer of the graphical user interface, or any other party designated by the distributor or developer. The price paid to display online content within an electronic shop may depend on the position of the shop within the stack (e.g., a price for shop 1772 may be higher or in some instances lower than a price for shop 1778). Additionally or alternatively, the price may depend upon one or more of a frequency at which a user or users access the electronic shop, a volume of purchases made by the user or users at the electronic shop, and a value of the purchases made by the user or users at the electronic shop.

In additional embodiments, Mall card 1717 may be linked to any arbitrary number of electronic shops, e.g., subgroup-level cards, without departing from the spirit of scope of the present invention. Further, respective electronic shops, which are linked to Mall card 1717, may be linked to any arbitrary number of department cards that provide links to any variety of merchandise without departing from the spirit or scope of the present invention.

In an embodiment, additional or alternate subgroup-level shop cards can be linked to Mall card 1717 based on a street address, a zip code, or any additional information associated with the user's computer system that would be apparent to one skilled in the art. For example, a subgroup-level shop card associated with a local pizza or Chinese restaurant may be linked to Mall card 1717, and the user may click on the respective shop card to display a menu and place an order for home delivery or for pickup.

### EXAMPLE 5

### A Graphical User Interface Acting as a Facilitator and Aggregator for Social Networking

A user of an existing social network, such as Facebook.com and MySpace.com, logs onto a website to post updates and information to be viewed by a group of friends, to view updates and information posted by members of this group of friends, and to chat with members of this group of friends. Further, the user may be a member of many social networks, each of which has a corresponding group of friends. As such, to keep up with the group of friends associated with each social network, the user must log into multiple websites to view and post updates and information. However, in addition to consuming time, these multiple logins can result in substantial redundancy, both for the user and for his or her friends, as a significant overlap may exist between the user's group of friends on one social network and the user's group of friends on one or more additional social networks.

In an embodiment, a graphical user interface of the present invention, e.g., the graphical user interfaces of FIGS. 16A-16C, facilitates social networking in a manner that bypasses existing social networking websites, such as MySpace.com and Facebook.com. In such an embodiment, the user no longer visits multiple social networking websites to network with his or her friends. Instead, the user shares and receives electronic assets (e.g., updates, messages, images, etc.) with one or more friends using the sharing capability of the graphical user interface, as described above. Such “auto-diffusion” of social networking data through the graphical user interface eliminates a need for the user to spend valuable time logging into multiple social networking websites.

In such an embodiment, the user of the graphical user interface can select a card within a card deck or bar to share with one or more friends. For example, and as described above in reference to FIGS. 16A-16C, the user may click on, hover over, or otherwise activate a share region of a selected card and indicate a group of friends to receive that card. The graphical user interface then delivers the selected card, and any electronic asset linked to the selected card and/or hierarchy of asset-level and subgroup-level cards linked to the selected card, to the group of friends.

For example, the user can select a card linked to a digital image that is to be shared with “Mom” and “Siblings” (e.g., “Mom” is an individual, and “Siblings” is a group of individuals). The selected card, along with the corresponding electronic asset, is shared with “Mom” and with each individual within the group of “Siblings.” The shared card appears within the Communicator card of the graphical user interface of each recipient, and a notification of the received card appears in a Communicator streamer of the graphical user interfaces of each recipient, as described above in reference to FIGS. 16A-16C (assuming that each intended recipient also uses the graphical user interface). In a similar fashion, whenever “Mom” wants to share a card with the user, or with a group of individuals that includes the user, “Mom” selects a card should be shared and indicates a set of intended recipients, whereupon her graphical user interface transmits the card to each specified recipient.

In the embodiments described above, the card could be linked to any number of electronic assets, either individually through respective asset-level cards, or collectively through a hierarchy of subgroup-level cards linked to additional asset-level and subgroup-level cards. Further, in additional embodiments, the user could share one or more cards with a group of friends using any of the various techniques described above.

In contrast to existing social networking websites, the graphical user interface operates by peer-to-peer diffusion and requires no centralized website or web service. Further, by monitoring the Communicator streamer, the user is continuously updated on social networking postings of his or her group of friends, since the Communicator streamer includes interwoven (or interleaved) postings received from friends of the user in chronological order, which are interspersed with the user's own emails and calendar items.

In an additional embodiment, the user can tune the Communicator stream of his or her graphical user interface to a particular “channel.” For example, the user's “Sister” is one member of the “Siblings” group. By tuning the Communicator stream to the “Sister” channel, the user can filter all content from the Communicator stream not received from “Sister,” and the resulting content may be displayed in the Communicator streamer in narrative or chronological order.

Further, for example, when the user joins a new group of friends, a new channel is automatically created in the user's Communicator that corresponds to the new group. Any posts from a member of that new group are marked with a corresponding channel identifier, and that channel identifier allows the graphical user interface to parse newly-received updates, posts, and messages from the new group or friend into the appropriate channel of the Communicator stream. In an embodiment, the updating described above may be performed manually by an administrator associated with each group. Additionally or alternatively, the updating process can be performed automatically using one or more deck-name servers, which respectively contain information of each registered person, group, and subgroup.

Communicator channels, such as the “Sister” channel described above, are additive rather than mutually exclusive. For example, the user can tune his or her Communicator stream to both the “Sister” channel, as described above, and an additional “User” channel, which would display all email and calendar items received by the user. In such an embodiment, content from both channels (i.e., “Sister” and “User”) can be interwoven into the user's Communicator stream. Further, in additional embodiment, the user may tune the Communicator stream to any number of arbitrary channels without departing from the spirit or scope of the present invention.

Further, social networking websites, such as Facebook.com, generally have a “wall” associated with each member onto which ongoing series of comments accumulate. For example, “Sister,” or any of her friends, may send the user a copy of “Sister's” wall card, which will be displayed within the user's Communicator streamer and linked to the user's Communicator card. When the user wishes to add a comment to “Sister's” wall card, the user accesses the wall card, adds one or more comments, and indicates that the wall card should be shared with “Sister” and her group of friends (assuming the a share-list or permissioning of the wall card is maintained when the wall card diffuses into a new stream). Further, if the user were to search the Communicator card for “Sister's” wall card, the search would return chronologically-ordered versions of the wall card that depict the progressive development of the wall card.

In the embodiments described above, the graphical user interface facilitates social networking without any need for a centralized website or web service. However, in additional embodiments, the graphical user interface can work in conjunction with existing websites, such as MySpace.com and Facebook.com, to facilitate social networking among one or more users of the graphical user interface. In such an embodiment, the graphical user interface would include a functionality to monitor updates to one or more “listed pages” of the user on one or more social networking websites and automatically package each update as a separate card to shared with the friends of the user (the sharing process is described above, for example, in reference to FIGS. 16A-16C). Such functionality may include sender-side software to monitor and translate these updates into a card format compatible with the graphical user interface. Further, the graphical user interface may also include functionality to regularly check each of the social networking profiles of the friends of the user on one or more websites, download any updates, and translate these updates into cards compatible with the graphical user interface of the user.

As such, the existing social networking websites are maintained and updated as before, but every update or new posting by any friend of the user automatically diffuses into the Communicator card and Communicator streamer of the user's graphical user interface, thereby aggregating information and updates from the friends of the user. Further, these embodiments allow the user to track his or her social network while concentrating on other tasks. For example, by keeping the Communicator card open on the graphical user interface, or by monitoring the Communicator streamer, the user can easily review and act upon any new posts or updates, both on large-screen displays, such as computer monitors, and small-screen displays characteristic of cellular telephones, smart phones, and personal digital assistants.

In additional embodiments, the social networking capabilities of the graphical user interface can be extended to commercial, organizational, or institutional group environments. In such environments, it is often important for members of the group to be part of and to track ongoing discussions between one or more members of the group, to have the capability to follow events, and to be informed of future events. This capability becomes especially important when an organization has more than one location or place of business and, additionally or alternatively, promotes telecommuting among its employees.

By logging into a graphical user interface, one or more remotely-situated employees can track current events and current topics of the discussion within various locations of the organization. Further, by tuning his or her Communicator streamer to the “Company” channel (or to a location-specific channel of the “Company”), a user of the graphical user interface in a commercial, organizational, or institutional environment can view postings relevant to the organization in a narrative or chronological order. For example, the Communicator streamer tuned to the “Company” channel could display to the user discussion leading up to a meeting, any exchanges of information during the meeting, and any follow-up discussion to the meeting.

### Exemplary Computer Systems

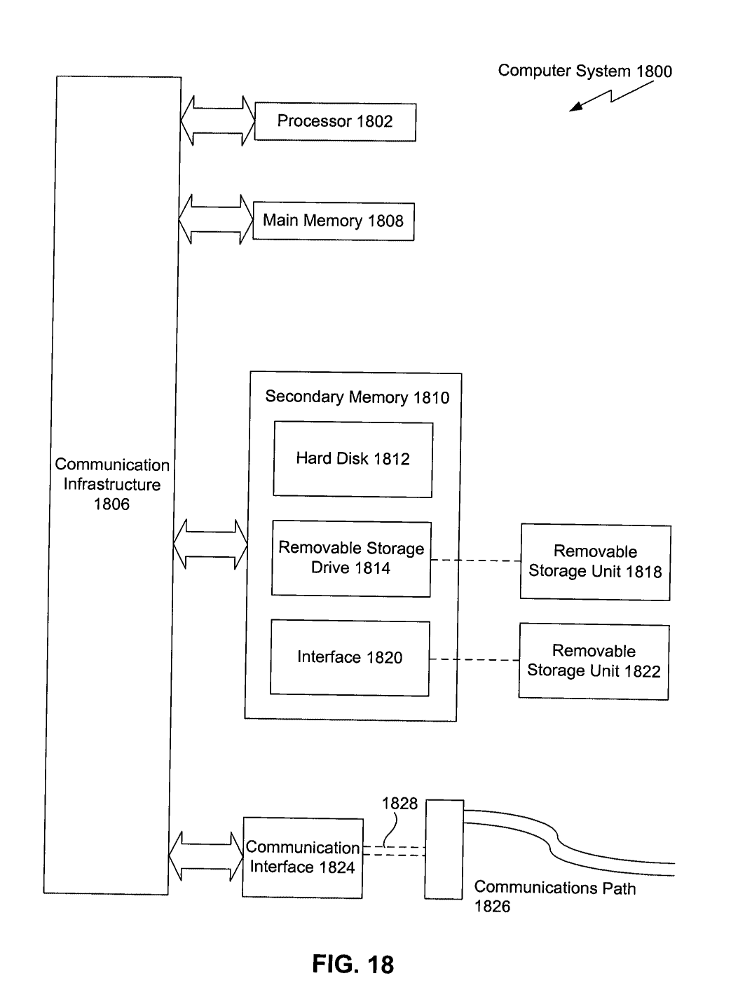

FIG. 18 is an exemplary computer architecture 1800 upon which the graphical user interfaces, methods, and computer program products of the present invention may be implemented, according to an embodiment of the invention. Exemplary computer system 1800 includes one or more processors, such as processor 1802. The processor 1802 is connected to a communication infrastructure 1806, such as a bus or network. Various example software implementations are described in terms of this exemplary computer system. After reading this description, it will become apparent to a person skilled in the relevant art how to implement the invention using other computer systems and/or computer architectures.

Computer system 1800 also includes a main memory 1808, preferably random access memory (RAM), and may include a secondary memory 1810. The secondary memory 1810 may include, for example, a hard disk drive 1812 and/or a removable storage drive 1814, representing a magnetic tape drive, an optical disk drive, CD/DVD drive, etc. The removable storage drive 1814 reads from and/or writes to a removable storage unit 1818 in a well-known manner. Removable storage unit 1818 represents a magnetic tape, optical disk, or other storage medium that is read by and written to by removable storage drive 1814. As will be appreciated, the removable storage unit 1818 can include a computer usable storage medium having stored therein computer software and/or data.

In alternative implementations, secondary memory 1810 may include other means for allowing computer programs or other instructions to be loaded into computer system 1800. Such means may include, for example, a removable storage unit 1822 and an interface 1820. An example of such means may include a removable memory chip (such as an EPROM, or PROM) and associated socket, or other removable storage units 1822 and interfaces 1820, which allow software and data to be transferred from the removable storage unit 1822 to computer system 1800.

Computer system 1800 may also include one or more communications interfaces, such as communications interface 1824. Communications interface 1824 allows software and data to be transferred between computer system 1800 and external devices. Examples of communications interface 1824 may include a modem, a network interface (such as an Ethernet card), a communications port, a PCMCIA slot and card, etc. Software and data transferred via communications interface 1824 are in the form of signals 1828, which may be electronic, electromagnetic, optical or other signals capable of being received by communications interface 1824. These signals 1828 are provided to communications interface 1824 via a communications path (i.e., channel) 1826. This channel 1826 carries signals 1828 and may be implemented using wire or cable, fiber optics, an RF link and other communications channels. In an embodiment of the invention, signals 1828 comprise data packets sent to processor 1802. Information representing processed packets can also be sent in the form of signals 1828 from processor 1802 through communications path 1826.

The terms “computer program medium” and “computer usable medium” are used to refer generally to media such as removable storage units 1818 and 1822, a hard disk installed in hard disk drive 1812, and signals 1828, which provide software to the computer system 1800.

Computer programs are stored in main memory 1808 and/or secondary memory 1810. Computer programs may also be received via communications interface 1824.

Such computer programs, when executed, enable the computer system 1800 to implement the present invention as discussed herein. In particular, the computer programs, when executed, enable the processor 1802 to implement the present invention. Where the invention is implemented using software, the software may be stored in a computer program product and loaded into computer system 1800 using removable storage drive 1814, hard drive 1812 or communications interface 1824.

In an embodiment, computer-program code for an operating system can be stored on one or more of removable storage drive 1814 and hard drive 1812, or alternatively, can be loaded into computer system 1800 over communications interface 1824. The operating system can, in various embodiments, manage the activities of and the sharing of resources of computer system 1800, serve as a host for application programs executed by processor 1802, and manage the operation of any hardware associated with computer system 1800.

Exemplary operating systems include, but are not limited to, Windows XP and Windows Vista, Mac OS X Leopard, and variants of Linux and Unix. Further, additional exemplary operating systems include those commonly used on personal digital assistants (PDAs) and smart phones. Such operating systems include, but are not limited to, Palm OS, Windows CE, Symbian, Android, and various operating systems based on the Linux operating system, such as LiMo, LinuxCE and OpenPDA.

In an embodiment, the graphical user interface of the present invention, as described above, may be an application executed on the operating system of a user's desktop computer, laptop computer, PDA, smart phone, or other device. In such an embodiment, the graphical user interface of the present invention serves as an interface between the operating system and a user, and the graphical user interface leverages an existing file system structure of the operating system to generate the above-described embodiments. Further in such an embodiment, the graphical user interface can be obtained and installed by the user on the device after the operating system is installed and operational, or alternatively, the operating system and the graphical user interface may be bundled and installed as a single unit.

However, the present invention is not limited to a graphical user interface executed by an operating system. In additional embodiments, the graphical user interface of the present invention can serve as an operating system for the user's desktop computer, laptop computer, PDA, smart phone, or other device apparent to one skilled in the art. In such an embodiment, no additional operating system would need be installed on the device, and the graphical user interface would be stored and executed natively on any hardware associated with the user's device (e.g., stored on removable storage drive 1814 or hard drive 1812 and executed by processor 1802). Moreover, the graphical user interface of the present invention can be provided in any combination of software, hardware, firmware, embedded systems, or other means by which a device may read and process the graphical user interface.

### Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments fully reveal the general nature of the invention so that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method comprising:
creating a representation of an asset as an asset card;
creating a representation of one or more asset cards as a group card;
organizing one or more group cards and/or asset cards in a portion of a card deck; and
displaying the card deck.

2. The method of claim 1, wherein the asset is stored either locally or remotely.

3. The method of claim 1, wherein the asset card and/or the group card are stored either locally or remotely.

4. The method of claim 1, further comprising:
determining that the asset card or the group card are set to be synchronized to a cloud computing system; and
storing the asset card or the group card at the cloud computing system.

5. The method of claim 4, further comprising:
accessing the asset card or the group card from the cloud computing system to display a synchronized, place-shifted card deck.

6. The method of claim 1, wherein organizing the one or more group cards and/or asset cards comprises:
arranging the one or more group cards and/or asset cards according to an arrangement algorithm.

7. The method of claim 1, further comprising:
specifying a recipient of the asset card or the group card; and
sharing the asset card or the group card with the recipient.

8. The method of claim 7, wherein the recipient has a device capable of displaying the asset card or the group card, the sharing comprising:
establishing a peer-to-peer connection with the recipient; and
providing the recipient with a notification when the asset card or the group card is received.

9. The method of claim 7, wherein the recipient does not have a device capable of displaying the asset card or the group card, the sharing comprising:
converting the asset card or the group card into a format accessible to the recipient; and
transmitting the converted asset card or the group card to the recipient.

10. The method of claim 9, wherein the format accessible to the recipient is an e-mail attachment.

11. The method of claim 1, further comprising:
creating a stream of available content from a combination of one or more content sources;
displaying the stream within a real-time desktop viewer.

12. The method of claim 11, wherein the content sources comprise comprising online content, content from a local storage location, accessible content from a remote storage location, incoming communications, and/or active media.

13. The method of claim 11, wherein the content sources comprise the asset card and/or the group card.

14. The method of claim 11, further comprising:
continuously streaming one of the one or more content sources within the stream until the one of the one or more content sources is acknowledged.

15. The method of claim 11, further comprising:
receiving an instruction to time-shift forward one of the one or more content sources;
removing the one of the one or more content sources from the stream; and
re-inserting the one of the one or more content sources into the stream when a time condition specified by the instruction is met.

16. The method of claim 11, further comprising:
receiving an instruction to time-shift backward an additional content source; and
inserting the additional content source into the stream when a time condition specified by the instruction is met.

17. A computer-readable medium having computer-executable instructions stored thereon that, if executed by a computing device, cause the computing device to perform a method comprising:
creating a representation of an asset as an asset card;
creating a representation of one or more asset cards as a group card;
organizing one or more group cards and/or asset cards in a portion of a card deck; and
displaying the card deck.

18. The computer-readable medium of claim 17, wherein the asset is stored either locally or remotely.

19. The computer-readable medium of claim 17, wherein the asset card and/or the group card are stored either locally or remotely.

20. The computer-readable medium of claim 17, the method further comprising:
determining that the asset card or the group card are set to be synchronized to a cloud computing system; and
storing the asset card or the group card at the cloud computing system.

21. The computer-readable medium of claim 20, the method further comprising:
accessing the asset card or the group card from the cloud computing system to display a synchronized, place-shifted card deck.

22. The computer-readable medium of claim 17, wherein organizing the one or more group cards and/or asset cards comprises:
arranging the one or more group cards and/or asset cards according to an arrangement algorithm.

23. The computer-readable medium of claim 17, the method further comprising:
specifying a recipient of the asset card or the group card; and
sharing the asset card or the group card with the recipient.

24. The computer-readable medium of claim 23, wherein the recipient has a device capable of displaying the asset card or the group card, the sharing comprising:
establishing a peer-to-peer connection with the recipient; and
providing the recipient with a notification when the asset card or the group card is received.

25. The computer-readable medium of claim 23, wherein the recipient does not have a device capable of displaying the asset card or the group card, the sharing comprising:
converting the asset card or the group card into a format accessible to the recipient; and
transmitting the converted asset card or the group card to the recipient.

26. The computer-readable medium of claim 25, wherein the format accessible to the recipient is an e-mail attachment.

27. The computer-readable medium of claim 17, the method further comprising:
creating a stream of available content from a combination of one or more content sources;
displaying the stream within a real-time desktop viewer.

28. The computer-readable medium of claim 27, wherein the content sources comprise comprising online content, content from a local storage location, accessible content from a remote storage location, incoming communications, and/or active media.

29. The computer-readable medium of claim 27, wherein the content sources comprise the asset card and/or the group card.

30. The computer-readable medium of claim 27, the method further comprising:
continuously streaming one of the one or more content sources within the stream until the one of the one or more content sources is acknowledged.

31. The computer-readable medium of claim 27, the method further comprising:
receiving an instruction to time-shift forward one of the one or more content sources;
removing the one of the one or more content sources from the stream; and
re-inserting the one of the one or more content sources into the stream when a time condition specified by the instruction is met.

32. The computer-readable medium of claim 27, the method further comprising:
receiving an instruction to time-shift backward an additional content source; and
inserting the additional content source into the stream when a time condition specified by the instruction is met.

33. A system comprising:
a memory storing:
a first module configured to create a representation of an asset as an asset card;
a second module configured to create a representation of one or more asset cards as a group card;
a third module configured to organize one or more group cards and/or asset cards in a portion of a card deck; and
a fourth module configured to display the card deck; and
one or more processors configured to process the modules.
